(19) United States
(12) Patent Application Publication
(10) Pub. No.: US 2019/0264878 A1
(43) Pub. Date: Aug. 29, 2019

(54) TECHNOLOGIES FOR ILLUMINATION

(71) Applicant: WEWORK COMPANIES INC., New York, NY (US)

(72) Inventor: Dror Benshetrit, New York, NY (US)

(21) Appl. No.: 16/334,711

(22) PCT Filed: Sep. 19, 2017
(86) PCT No.: PCT/US17/52295

§ 371 Date: Mar. 19, 2019

Related U.S. Application Data
(60) Provisional application No. 62/396,700, filed on Sep. 19, 2016.

(51) Int. Cl. F21K 9/237; F21K 9/232; F21K 9/235; F21L 4/00; F21S 9/03; F21V 17/00; F21V 19/04; F21V 23/06; F21V 33/00; F21S 6/00; F21V 21/06; F21V 3/02

(52) U.S. Cl. CPC F21K 9/237; F21K 9/232; F21K 9/235; F21L 4/005; F21S 9/035; F21V 17/002; F21Y 2103/00; F21V 23/06; F21V 33/0096; F21S 6/005; F21V 17/007; F21V 21/06; F21V 3/02; F21V 19/04

(57) ABSTRACT

An illumination technology is disclosed. The illumination technology can be embodied in various forms. Some of such forms include a light bulb, an adapter, a base, a light fixture, and others.

### CROSS REFERENCE TO RELATED APPLICATIONS

This application claims a benefit of U.S. Provisional Application 62/396,700 filed 19 Sep. 2016, which is incorporated herein by reference in its entirety for all purposes.

### TECHNICAL FIELD

This disclosure relates to illumination.

### BACKGROUND

In this disclosure, where a document, an act, and/or an item of knowledge is referred to and/or discussed, then such reference and/or discussion is not an admission that the document, the act, and/or the item of knowledge and/or any combination thereof was at a priority date, publicly available, known to a public, part of common general knowledge, and/or otherwise constitutes any prior art under any applicable statutory provisions; and/or is known to be relevant to any attempt to solve any problem with which this disclosure may be concerned with. Further, nothing is disclaimed.

An incandescent bulb contains a wire filament, a glass casing, and an Edison screw. The wire filament is heated to a high temperature via passing an electric current therethrough until the wire filament glows with a visible light, which is known as an incandescence. The glass casing is filled with an inert gas in order to reduce an evaporation of the wire filament and insulate for a heat loss, thereby extending a lifespan of the wire filament. The Edison screw is attached to the glass casing and is used as a standardized connector for threading into a bulb socket.

Various improvements to the incandescent bulb have been devised. Some of such improvements include a fluorescent bulb and a light emitting diode (LED) bulb. However, even such improvements have various drawbacks. For example, each of the fluorescent bulb and the LED bulb is bulky for shipping, such as due to bulb shape or size. Likewise, each of the fluorescent bulb and the LED bulb cannot be assembled/disassembled for a selectively interchangeable use, as needed. Moreover, each of the fluorescent bulb and the LED bulb cannot be used without a bulb socket. Additionally, each of the fluorescent bulb and the LED bulb cannot be powered via a battery. Further, for each of the fluorescent bulb and the LED bulb, more than one bulb cannot be installed into a bulb socket. Also, the LED bulb contains a heat sink, which complicates bulb design and adds cost. Accordingly, there is a desire to address at least one of such drawbacks.

### BRIEF SUMMARY

This disclosure may at least partially address at least one of above inefficiencies. However, this disclosure can prove useful to other technical areas. Therefore, various claims recited below should not be construed as necessarily limited to addressing any of the above inefficiencies.

According to an embodiment of this disclosure, a device comprises: a light bulb including a platform, a casing, and an LED filament, wherein the platform is coupled to the casing, wherein the platform is coupled to the LED filament, wherein the casing encases the LED filament, wherein the casing is tubular, wherein the LED filament extends longitudinally along the casing.

According to an embodiment of this disclosure, a device comprises: an adapter including a screw and a wall, wherein the screw is coupled to the wall, wherein the wall defines a well configured to receive a light bulb and power the light bulb.

According to an embodiment of this disclosure, a device comprises: a disk including a plurality of photovoltaic cells; and a receiver supported via the disk, wherein the receiver is configured to receive a light bulb and power the light bulb based on the photovoltaic cells.

According to an embodiment of this disclosure, a device comprises: a light fixture comprising a wall with a non-threaded well, wherein the non-threaded well is configured to securely receive a light bulb and power the light bulb.

This disclosure may be embodied in various forms illustrated in a set of accompanying illustrative drawings. Note that variations are contemplated as being a part of this disclosure, limited only by a scope of various claims recited below.

### BRIEF DESCRIPTION OF DRAWINGS

A set of accompanying illustrative drawings shows various example embodiments of this disclosure. Such drawings are not to be construed as necessarily limiting this disclosure. Like numbers and/or similar numbering scheme can refer to like and/or similar elements throughout.

FIG. 1 shows a perspective view of an embodiment of a light bulb and a close-up view of an embodiment of a light bulb casing enclosing a plurality of LED filaments according to this disclosure.

FIG. 2 shows a cross-sectional view of an embodiment a light bulb according to this disclosure.

FIG. 2a shows a cross-sectional view of an embodiment of a base of a light bulb according to this disclosure.

FIG. 3 shows a perspective view of an embodiment of a light bulb according to this disclosure.

FIG. 3a shows a bottom view of an embodiment of a base of a light bulb according to this disclosure.

FIG. 4a shows a perspective view of an embodiment of an Edison base according to this disclosure.

FIG. 4b shows a top view of an embodiment of an Edison base according to this disclosure.

FIG. 5 shows a schematic view of an embodiment of an Edison base according to this disclosure.

FIG. 6 shows a perspective view of a plurality of embodiments of a plurality of bulb receiving portions of an Edison base according to this disclosure.

FIG. 7 shows a perspective view of an embodiment of a packaging configuration according to this disclosure.

FIG. 8 shows a perspective view of a plurality of embodiments of a plurality of bulb casings according to this disclosure.

FIG. 9 shows a perspective view of an embodiment of a solar-powered assembly according to this disclosure.

FIG. 9a shows a cross-sectional view of an embodiment of a well of a solar-powered assembly according to this disclosure.

FIG. 9b shows a cross-sectional view of an embodiment of a well of a solar-powered assembly according to this disclosure.

FIG. 10 shows a schematic view of an embodiment of a solar-powered assembly according to this disclosure.

FIG. 11 shows a top view of an embodiment of a solar-powered assembly according to this disclosure.

FIG. 12 shows a perspective view of an embodiment of a photovoltaic base according to this disclosure.

FIG. 13 shows a perspective view of a plurality of embodiments of a plurality of photovoltaic bases according to this disclosure.

FIG. 14 shows a perspective view of an embodiment of a light fixture structured to receive a light bulb according to this disclosure.

FIG. 15 shows a perspective view of an embodiment of a light fixture structured to receive an Edison base, where the Edison base is structured to receive a light bulb according to this disclosure.

FIG. 16 shows a schematic view of an embodiment of an Edison base comprising a sensor or a transmitter according to this disclosure.

FIG. 17 shows a perspective view of an embodiment of an Edison base comprising a sensor or a transmitter according to this disclosure.

FIG. 18 shows a perspective view of an embodiment of an Edison base structured to receive a plurality of light bulbs according to this disclosure.

FIG. 19 shows a perspective view of a plurality of embodiments of a plurality of light bulb coupling mechanisms according to this disclosure.

FIG. 20 shows a schematic view of an embodiment of an Edison base with a battery according to this disclosure.

FIG. 21 shows a perspective view of an embodiment of an Edison base with a light property control element according to this disclosure.

FIG. 22 shows a perspective view of an embodiment of a photovoltaic base electrically coupled to a battery according to this disclosure.

FIG. 23 shows a schematic view of an embodiment of a photovoltaic base electrically coupled to a battery according to this disclosure.

FIG. 24 shows a schematic view of an embodiment of a self-learning battery management system according to this disclosure.

FIG. 25 shows a flowchart of an embodiment of a process for self-learning battery management according to this disclosure.

FIG. 26 shows a schematic diagram of a plurality of embodiments of a plurality of fold lines for a plurality of photovoltaic bases according to this disclosure.

FIG. 27 shows a perspective view of an embodiment of a flashlight comprising a light bulb according to this disclosure.

FIG. 28 shows a perspective view of an embodiment of a vehicle comprising a light bulb according to this disclosure.

FIG. 29 shows a cross-sectional view of an embodiment of a container storing a plurality of light bulbs according to this disclosure.

FIG. 30 shows a perspective view of an embodiment of an adapter and a light bulb coupled thereto and a solar-powered lantern according to this disclosure.

FIG. 31 shows a side view of an embodiment of an illumination device according to this disclosure.

FIG. 32 shows a side view of an embodiment of an illumination device according to this disclosure.

FIG. 33 shows a perspective view of an embodiment of a solar-powered lantern according to this disclosure.

FIG. 34 shows a perspective view of an embodiment of a solar-powered lantern according to this disclosure.

FIG. 35 shows a side view of an embodiment of a light bulb according to this disclosure.

FIG. 36 shows a side view of an embodiment of a module assembly according to this disclosure.

FIG. 37 shows a side view of an embodiment of an illumination device according to this disclosure.

FIG. 38 shows a side view of an embodiment of a modular component system according to this disclosure.

FIG. 39 shows a side view of an embodiment of a use of a modular component system according to this disclosure.

FIGS. 40A-40C show a plurality of side views of a plurality of embodiments of a plurality of light bulbs, where each of the light bulbs includes a plurality of LED filaments of various optical properties according to this disclosure.

FIG. 41 shows a diagram depicting an embodiment of a relationship between a luminosity scale and a Kelvin scale according to this disclosure.

### DETAILED DESCRIPTION OF PREFERRED EMBODIMENTS

This disclosure is now described more fully with reference to the set of accompanying illustrative drawings, in which example embodiments of this disclosure are shown. This disclosure may, however, be embodied in many different forms and should not be construed as necessarily being limited to the example embodiments disclosed herein. Rather, the example embodiments are provided so that this disclosure is thorough and complete, and fully conveys various concepts of this disclosure to those skilled in a relevant art.

Features described with respect to certain example embodiments may be combined and sub-combined in and/or with various other example embodiments. Also, different aspects and/or elements of example embodiments, as disclosed herein, may be combined and sub-combined in a similar manner as well. Further, some example embodiments, whether individually and/or collectively, may be components of a larger system, wherein other procedures may take precedence over and/or otherwise modify their application. Additionally, a number of steps may be required before, after, and/or concurrently with example embodiments, as disclosed herein. Note that any and/or all methods and/or processes, at least as disclosed herein, can be at least partially performed via at least one entity in any manner.

Various terminology used herein can imply direct or indirect, full or partial, temporary or permanent, action or inaction. For example, when an element is referred to as being “on,” “connected” or “coupled” to another element, then the element can be directly on, connected or coupled to the other element and/or intervening elements can be present, including indirect and/or direct variants. In contrast, when an element is referred to as being “directly connected” or “directly coupled” to another element, there are no intervening elements present.

Although the terms first, second, etc. can be used herein to describe various elements, components, regions, layers and/or sections, these elements, components, regions, layers and/or sections should not necessarily be limited by such terms. These terms are used to distinguish one element, component, region, layer or section from another element, component, region, layer or section. Thus, a first element, component, region, layer, or section discussed below could be termed a second element, component, region, layer, or section without departing from various teachings of this disclosure.

Various terminology used herein is for describing particular example embodiments and is not intended to be necessarily limiting of this disclosure. As used herein, various singular forms “a,” “an” and “the” are intended to include various plural forms as well, unless a context clearly indicates otherwise. Various terms “comprises,” “includes” and/or “comprising,” “including” when used in this specification, specify a presence of stated features, integers, steps, operations, elements, and/or components, but do not preclude the presence and/or addition of one or more other features, integers, steps, operations, elements, components, and/or groups thereof.

As used herein, a term “or” is intended to mean an inclusive “or” rather than an exclusive “or.” That is, unless specified otherwise, or clear from context, “X employs A or B” is intended to mean any of a set of natural inclusive permutations. That is, if X employs A; X employs B; or X employs both A and B, then “X employs A or B” is satisfied under any of the foregoing instances.

Example embodiments of this disclosure are described herein with reference to illustrations of idealized embodiments (and intermediate structures) of this disclosure. As such, variations from various illustrated shapes as a result, for example, of manufacturing techniques and/or tolerances, are to be expected. Thus, various example embodiments of this disclosure should not be construed as necessarily limited to various particular shapes of regions illustrated herein, but are to include deviations in shapes that result, for example, from manufacturing.

Any and/or all elements, as disclosed herein, can be formed from a same, structurally continuous piece, such as being unitary, and/or be separately manufactured and/or connected, such as being an assembly and/or modules. Any and/or all elements, as disclosed herein, can be manufactured via any manufacturing processes, whether additive manufacturing, subtractive manufacturing, and/or other any other types of manufacturing. For example, some manufacturing processes include three dimensional (30) printing, laser cutting, computer numerical control routing, milling, pressing, stamping, vacuum forming, hydroforming, injection molding, lithography, and so forth.

Any and/or all elements, as disclosed herein, can be and/or include, whether partially and/or fully, a solid, including a metal, a mineral, an amorphous material, a ceramic, a glass ceramic, an organic solid, such as wood and/or a polymer, such as rubber, a composite material, a semiconductor, a nanomaterial, a biomaterial and/or any combinations thereof. Any and/or all elements, as disclosed herein, can be and/or include, whether partially and/or fully, a coating, including an informational coating, such as ink, an adhesive coating, a melt-adhesive coating, such as vacuum seal and/or heat seal, a release coating, such as tape liner, a low surface energy coating, an optical coating, such as for tint, color, hue, saturation, tone, shade, transparency, translucency, opaqueness, luminescence, reflection, phosphorescence, anti-reflection and/or holography, a photo-sensitive coating, an electronic and/or thermal property coating, such as for passivity, insulation, resistance or conduction, a magnetic coating, a water-resistant and/or waterproof coating, a scent coating and/or any combinations thereof. Any and/or all elements, as disclosed herein, can be rigid, flexible, and/or any other combinations thereof. Any and/or all elements, as disclosed herein, can be identical and/or different from each other in material, shape, size, color and/or any measurable dimension, such as length, width, height, depth, area, orientation, perimeter, volume, breadth, density, temperature, resistance, and so forth.

Unless otherwise defined, all terms (including technical and scientific terms) used herein have the same meaning as commonly understood by one of ordinary skill in an art to which this disclosure belongs. Various terms, such as those defined in commonly used dictionaries, should be interpreted as having a meaning that is consistent with a meaning in a context of a relevant art and should not be interpreted in an idealized and/or overly formal sense unless expressly so defined herein.

Furthermore, relative terms such as “below,” “lower,” “above,” and “upper” can be used herein to describe one element's relationship to another element as illustrated in the set of accompanying illustrative drawings. Such relative terms are intended to encompass different orientations of illustrated technologies in addition to an orientation depicted in the set of accompanying illustrative drawings. For example, if a device in the set of accompanying illustrative drawings were turned over, then various elements described as being on a “lower” side of other elements would then be oriented on “upper” sides of other elements. Similarly, if a device in one of illustrative figures were turned over, then various elements described as “below” or “beneath” other elements would then be oriented “above” other elements. Therefore, various example terms “below” and “lower” can encompass both an orientation of above and below.

As used herein, a term “about” and/or “substantially” refers to a +/−10% variation from a nominal value/term. Such variation is always included in any given value/term provided herein, whether or not such variation is specifically referred thereto.

If any disclosures are incorporated herein by reference and such disclosures conflict in part and/or in whole with this disclosure, then to an extent of a conflict, if any, and/or a broader disclosure, and/or broader definition of terms, this disclosure controls. If such disclosures conflict in part and/or in whole with one another, then to an extent of a conflict, if any, a later-dated disclosure controls.

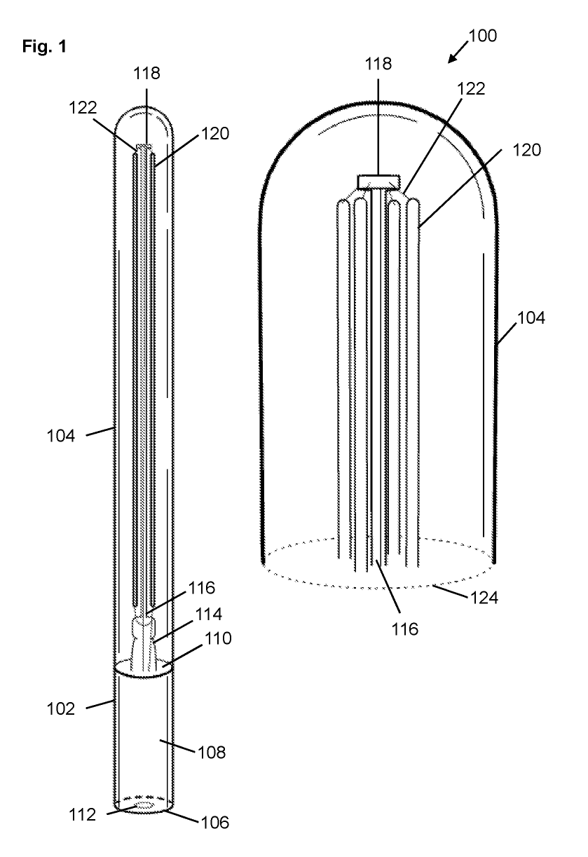

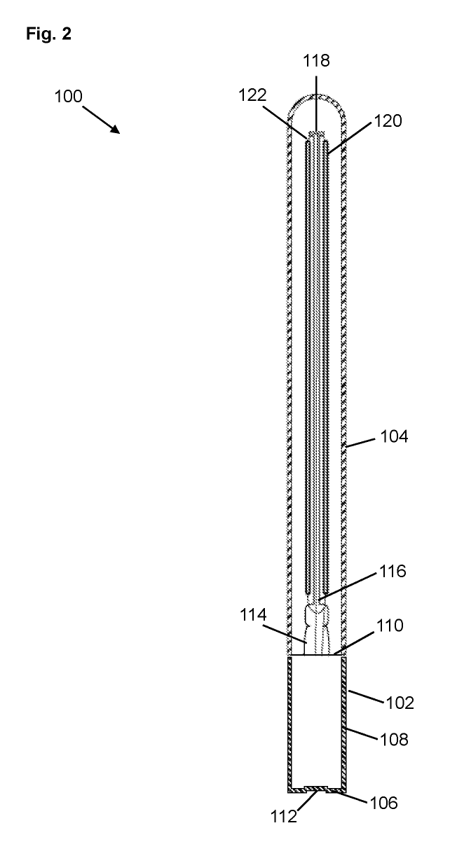

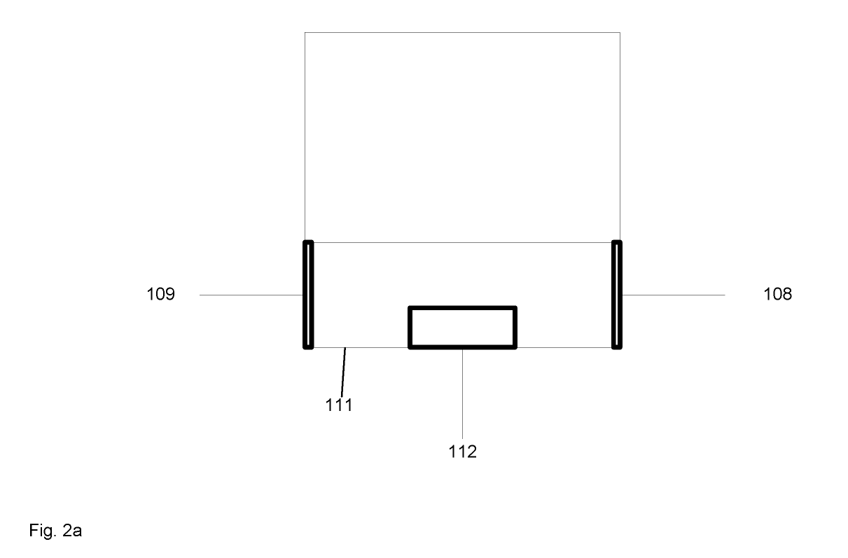

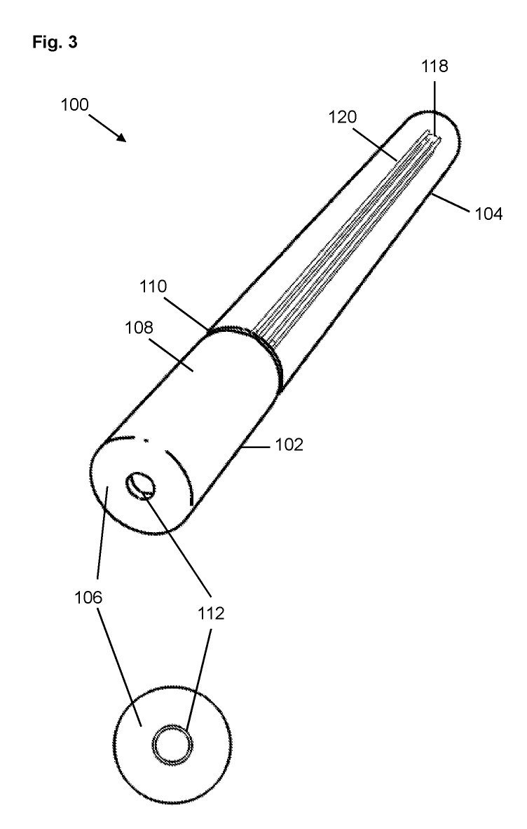

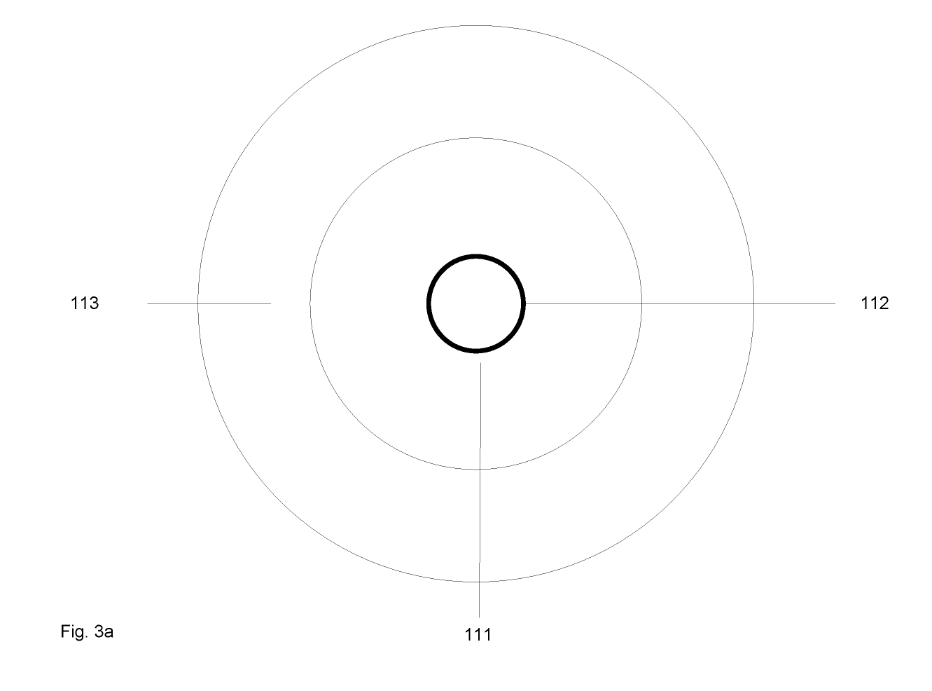

FIG. 1 shows a perspective view of an embodiment of a light bulb and a close-up view of an embodiment of a light bulb casing enclosing a plurality of LED filaments according to this disclosure. FIG. 2 shows a cross-sectional view of an embodiment of a light bulb according to this disclosure. FIG. 2a shows a cross-sectional view of an embodiment of a base of a light bulb according to this disclosure. FIG. 3 shows a perspective view of an embodiment of a light bulb according to this disclosure. FIG. 3a shows a bottom view of an embodiment of a base of a light bulb according to this disclosure.

A light bulb 100 comprises a platform/base 102 and a casing 104. The light bulb 100 also comprises a light source encased via the casing 104 and powered via the platform/base 102. The platform/base 102 is cylindrically shaped and comprises a lower base 106, a sidewall 108, and an upper base 110. The sidewall 108 spans between the base 106 and the base 110. Although the base 106 is planar, the base 106 can be concave. The base 106 comprises a female portion 112, such as a depression with a terminal, configured for an electrical mating with a male portion, such as a projection with a terminal, such as to receive an electrical current for the light source. Although the portion 112 is circular, other shapes are possible, such as square, an oval, a triangle, a star, a pentagon, a trapezoid, or other closed or polygonal shape. In some embodiments, the base 106 comprise a male portion configured for an electrical mating with a female portion, such as to receive an electrical current for the light source. For example, the male portion can include a plurality of posts, pins, prongs, or other electrical connectors, some of which may be shaped as a looped pin, a twist lock, or others. At least one of the base 106, the sidewall 108, or the base 110 comprises a plastic, glass, or others, whether transparent, translucent, opaque, colored, or others. However, other materials can be included, whether additionally or alternatively, such as a wood, a metal, a rubber, or others.

The casing 104 extends from the base 106 in a tubular and elongated manner such that a diameter of the casing 104 is substantially uniform longitudinally, although non-uniform diameter is possible as well. The casing 104 is coupled to the base 106, such as in a cantilevered manner, such as via fastening, adhering, mating, or other coupling techniques. In some embodiments, the casing 104 is coupled to the sidewall 108. Although the sidewall 108 and the casing 104 are flush with respect to each other, non-flush configuration is possible as well. The casing 104 can be opaque, translucent, or transparent. The casing 104 can be any color, such as white, black, red, yellow, green, purple, orange, or others. The casing 104 comprises a glass or other suitable material. Note that although a distal portion of the casing 104 is convex, other shapes are possible, such as concave, orthogonal, conical, or others. In some embodiments, the casing 104 has a diameter 124, such as 6 centimeters or less. Note that the diameter 124 can be longitudinally uniform or varying. Also, note that although the casing 104 has a circular cross-section, other cross-sectional shapes are possible, such as oval, square, triangle, pentagon, octagon, or any other closed or polygonal shape. In some embodiments, the platform/base 102 and the casing 104 are unitary and can include a same material.

The light source comprises a pedestal 114, a support column 116, a disc 118, and a plurality of light filaments 120. Alternatively, the light source may comprise a single filament 120 in place of the filaments 120, which may extend in a rectilinear, sinusoidal, arcuate, helical, spherical, grid, annular, cylindrical, or other manners. The pedestal 114 is supported via and extends from the base 110 longitudinally, along the casing 104. The column 116 is supported via and extends from the pedestal 114 longitudinally, along the casing 104. The disc 118 is support via and extends from the column 116 laterally such that the disc 118 and the column 116 form a T-shape thereby. The pedestal 114, the support column 116, and the disc 118 comprise an electrically insulating material, whether identical to or different from each other, such as a porcelain, a glass, a rubber, a wood, a plastic, a fiberglass, a ceramic, a quartz, a polymer, a composite, or others.

As shown in FIG. 2a, the platform/base 102, such as in the sidewall 108, comprises a conductor 109, an insulator 111, and a conductor 112 to create an electrical current loop. For example, the conductor 109 can be ground and the portion 112 can be live. For example, the portion 112 is enclosed via the insulator 111, which in turn is enclosed via the conductor 109, where the portion 112 is live and the conductor 109 is ground. Similarly, as shown in FIG. 3a, the platform/base 102, such as in the base 106, comprises a conductor 113, an insulator 111, and a conductor 112 to create an electrical current loop. For example, the conductor 113 can be ground and the portion 112 can be live. For example, the portion 112 is enclosed via the insulator 111, which in turn is enclosed via the conductor 113, where the portion 112 is live and the conductor 113 is ground.

Each of the filaments 120 comprises a proximal portion and a distal portion. For each of the filaments 120, the proximal portion is coupled to the pedestal 114 via a first conductive wire and the distal portion is coupled to the disc 118 via a second conductive wire 122 such that a circuit is formed. Alternatively, each of the filaments 120 may be coupled to the pedestal 114 via two of the conductive wires 122 and coupled to the disc 118 via one or more support wires. Alternatively, each of the filaments 120 may be coupled to the disc 118 via two of the conductive wires 122 and coupled to the pedestal 114 via one or more support wires. The conductive wires 122 may form a parallel circuit with the filaments 120 or each LED emitter of one or more of the filaments 120. Alternatively, the conductive wires 122 may form a serial circuit with the filaments 120 or each LED emitter of one or more of the filaments 120. Each of the filaments 120 comprises a plurality of LED emitters arranged in a linear filament style package between the proximal portion and the distal portion. Therefore, the filaments 120 are longitudinally positioned to output an illumination therefrom, which may be in any color, such as red, blue, green, or others, including any combination of colors, ultraviolet, infrared, or white, in various intensities and tones. Some examples of the filaments 120 are disclosed in U.S. Patent Application Publication 20140369036, which is fully incorporated by reference herein for all purposes.

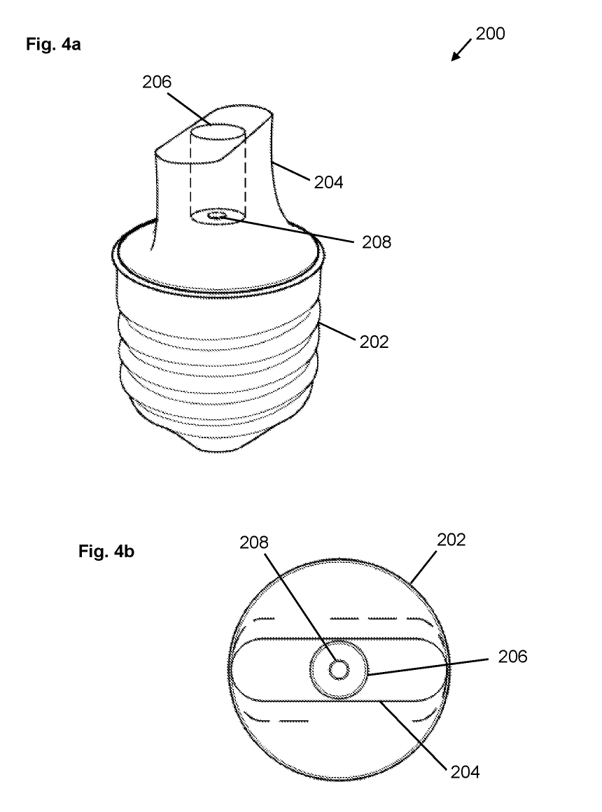

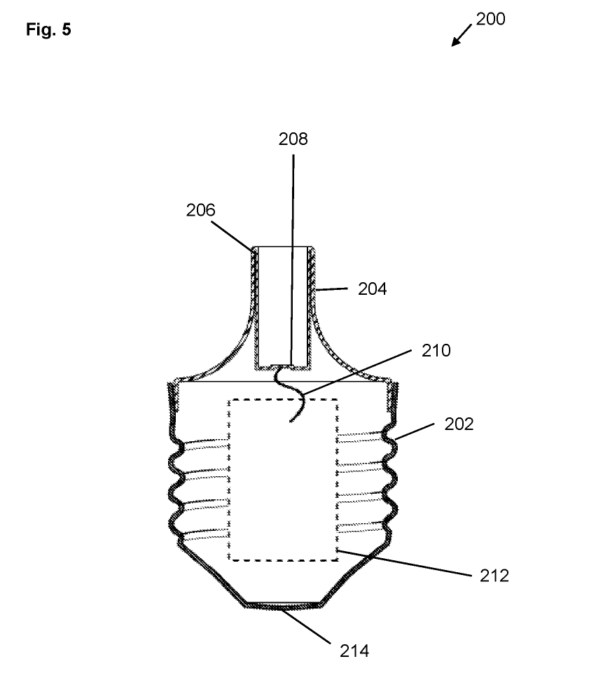

FIG. 4a shows a perspective view of an embodiment of an Edison base according to this disclosure. FIG. 4b shows a top view of an embodiment of an Edison base according to this disclosure. FIG. 5 shows a schematic view of an embodiment of an Edison base according to this disclosure. An Edison base 200 comprises an Edison screw 202 and a wall 204. The screw 202 is threaded, whether right-hand or left-hand, for an installation into a bulb socket, such as an Edison socket, in order to receive an electric current from the bulb socket for the light source. The screw 202 comprises a conductive wire 210, an electric circuit board 212, and a tip 214. The board 212 is electrically coupled to the tip 214 and the wire 210. The tip 214 is structured to receive an electric current from a bulb socket when the screw 202 is installed into the bulb socket. The board 212 is designed to facilitate a flow of an electric current from the tip 214 to the wire 210.

The wall 204 extends from the screw 202. The wall 204 is coupled to the screw 202, such as via fastening, adhering, mating, or other coupling techniques. The wall 204 is solid, but can be perforated. The wall 204 comprises an electrically insulating material, whether identical to or different from each other, such as a porcelain, a glass, a rubber, a wood, a plastic, a fiberglass, a ceramic, a quartz, a polymer, a composite, or others. The wall 204 comprises a top portion, which defines a well 206 into the wall 204. The well 206 is cylindrical with a circular cross-section, although other cross-sectional shapes are possible, such as square, an oval, a triangle, a star, a pentagon, a trapezoid, or other closed or polygonal shape. The well 206 comprises a base comprising a male portion 208, such as a projection with a terminal. The portion 208 is electrically coupled to the wire 210, such as to receive an electric current from the wire 210. The portion 208 is configured for an electrical mating with the portion 112, such as to conduct an electrical current for the light source. Note that the well 206 or a portion of the well 206 comprises a conductor, which may be ground, where the portion 208 is live. Although the portion 208 is circular, other shapes are possible, such as square, an oval, a triangle, a star, a pentagon, a trapezoid, or other closed or polygonal shape. In some embodiments, the base of the well 206 comprises a female portion, such as a depression with a terminal, configured for an electrical mating with a male portion, such as to conduct an electrical current for the light source.

As shown in FIGS. 1-5, and with respect to any embodiment disclosed herein, the light bulb 100 and the base 200 are distinct and separate devices. However, in other embodiments, and with respect to any embodiment disclosed herein, the light bulb 100 and the base 200 are a single device.

Further, note that although the base 200 is an Edison screw base, other types of bases 200 can be used, whether standardized, specialized, or customized. For example, the base 200 can be pin-based, such as 2-pin or 4-pin, a bayonet mount, a wedge base, or others. For example, the base 200 can be of various types, such as E5, E10, E11, E12, E14, E17, E26, E27, E29, E39, E40, or others. Likewise, the bulb 100 can be configured similarly to any of the bases 200 in any combinatory manner. Accordingly, many modular combinations of the bulb 100 and the base 200 exist.

FIG. 6 shows a perspective view of a plurality of embodiments of a plurality of bulb receiving portions of an Edison base according to this disclosure. An Edison base 600a comprises a wall 204a, which has a rectangular shape with a set of rounded corners. An Edison base 600b comprises a wall 204b, which has a rectangular shape with a set of acute corners. An Edison base 600c comprises a wall 204c, which has a plus-sign-shape or an X-shape with a set of acute corners, although one or more rounded corners is possible.

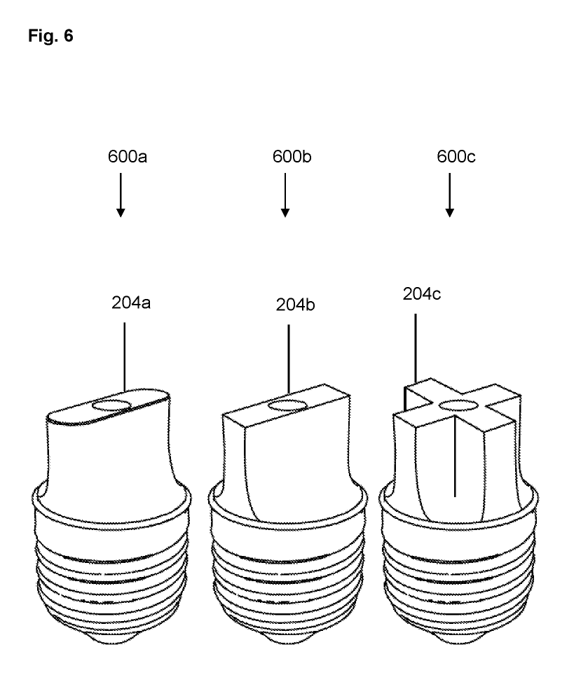

FIG. 7 shows a perspective view of an embodiment of a packaging configuration according to this disclosure. A packaging configuration 700 comprises a stack of containers 702, such as a cardboard, plastic, or paper box, where each of the containers 702 contains the Edison base 200. The configuration 700 also comprises a side-by-side positioning of containers 704, such as a cardboard, plastic, or paper box, where each of the containers 704 contains the light bulb 100. Although two of the containers 702 stacked have a height equivalent to a single container 704, such as each of the two containers 702 being a half of the height, in other embodiments, two of the containers 702 stacked have a height not equivalent to a single container 704. For example, a single container 702 may have a height equivalent to or greater than a single container 704. For example, a single container 704 may have a height less than a single container 702. A pallet 706 supports a plurality of containers 708, such as a cardboard, plastic, or paper box, where each of the containers 708 stores the containers 702. The pallet 706 also supports a plurality of 710, such as a cardboard, plastic, or paper box, where each of the containers 710 stores the containers 704.

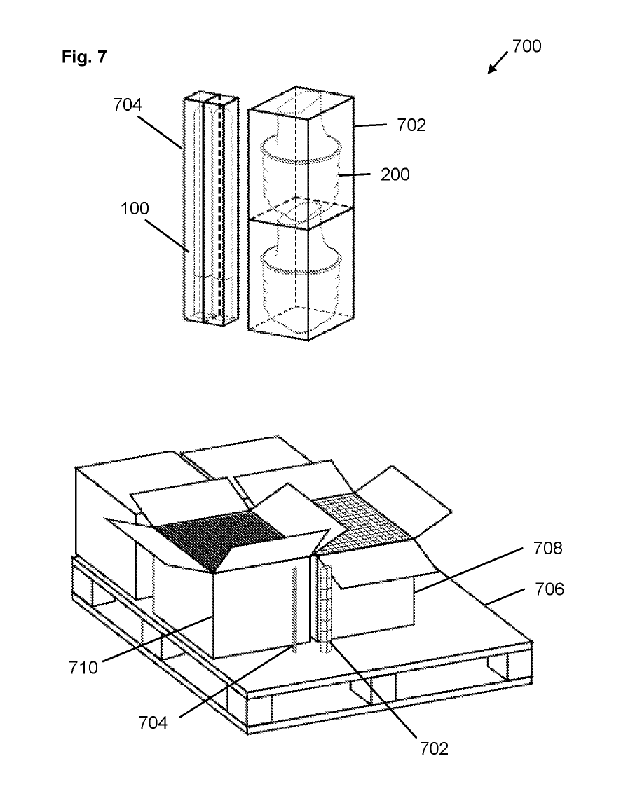

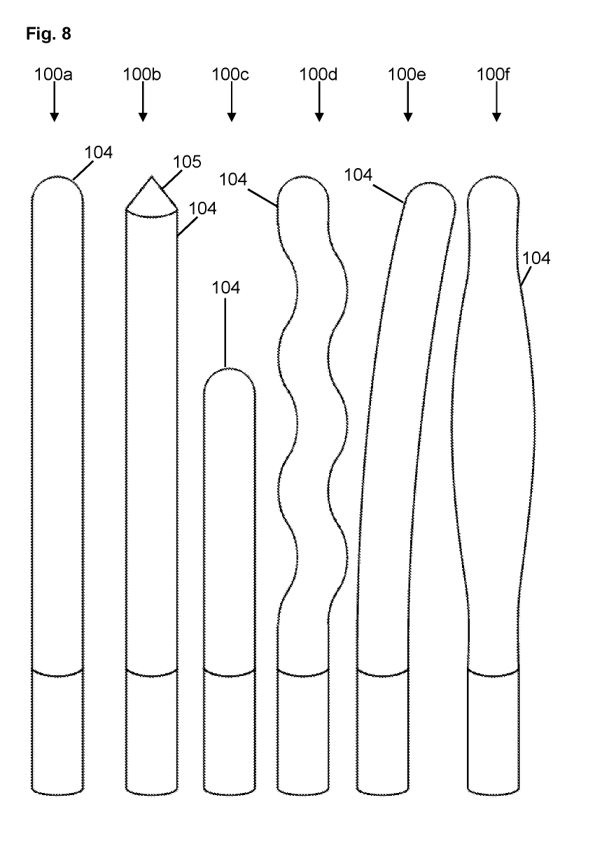

FIG. 8 shows a perspective view of a plurality of embodiments of a plurality of bulb casings according to this disclosure. A light bulb 100a comprises the casing 104, which is elongated, rectilinear, diametrically uniform, and tubular, with the distal end being convex. For example, the casing 104 can have a longitudinal length of 120 millimeters. A light bulb 100b comprises the casing 104, which is elongated, rectilinear, diametrically uniform, and tubular, with the distal end being tapered, conical, or pyramidal. A light bulb 100c comprises the casing 104, which is elongated, rectilinear, diametrically uniform, and tubular, with the distal end being convex, though the casing 104 is longitudinally shorter than the casing 104 in the light bulb 100a, such as 75 millimeters. A light bulb 100d comprises the casing 104, which is elongated, sinusoidal, diametrically uniform, and tubular, with the distal end being convex. A light bulb 100e comprises the casing 104, which is elongated, arcuate, diametrically uniform, and tubular, with the distal end being convex. A light bulb 100f comprises the casing 104, which is elongated, diametrically varying, and tubular, with the distal end being convex. Note that any of the light bulbs 100a, 100b, 100c, 100d, 100e, or 100f can be mixed and matched in any permutational manner. In some embodiments, the casing 104 is helical or spherical.

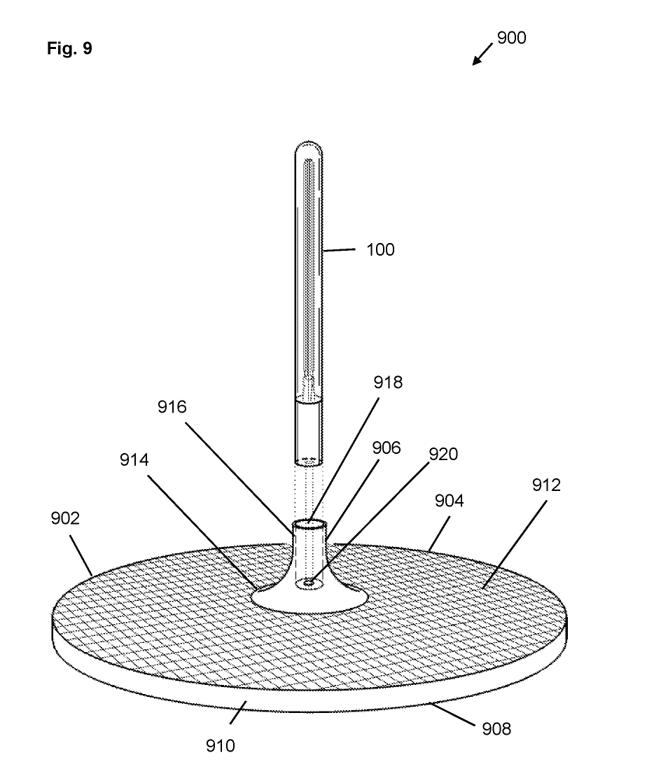

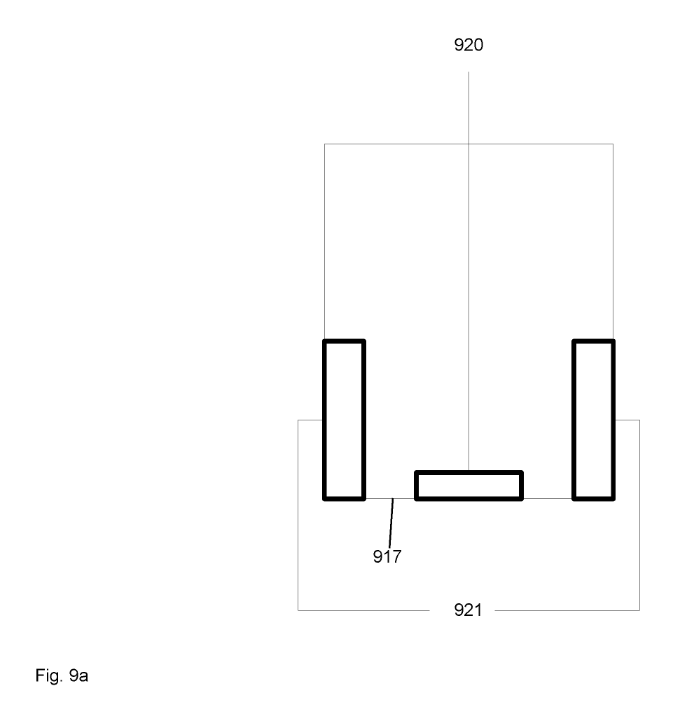

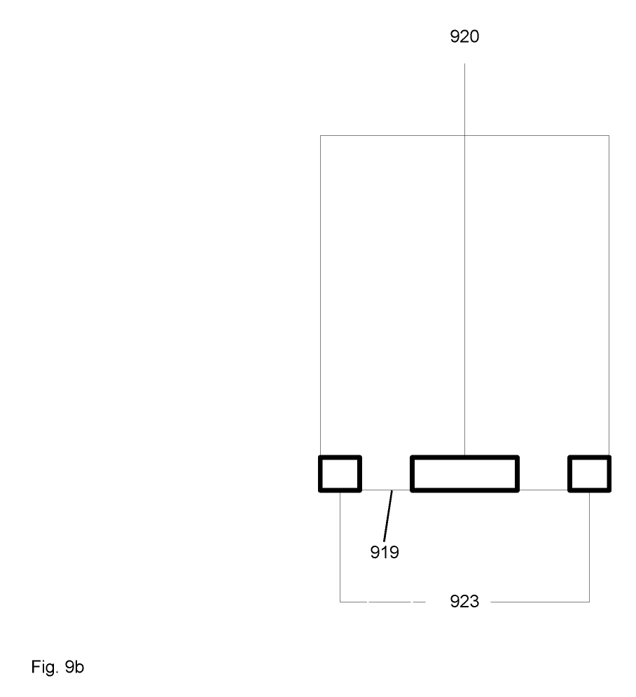

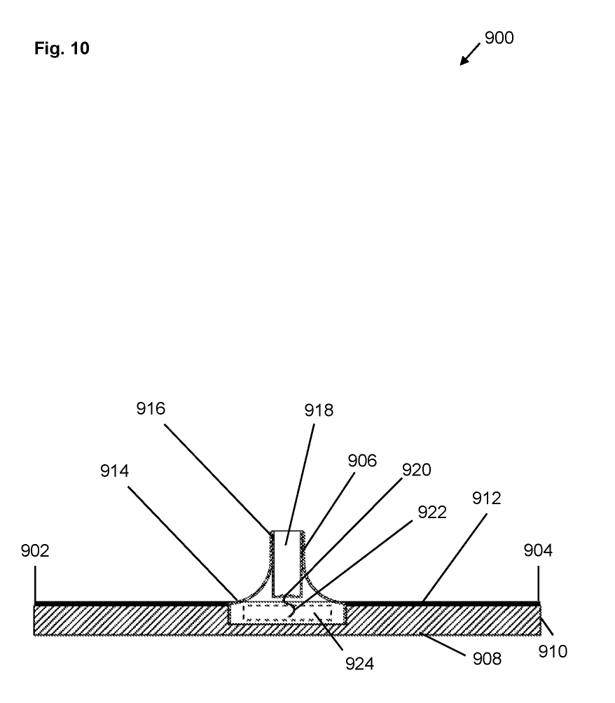

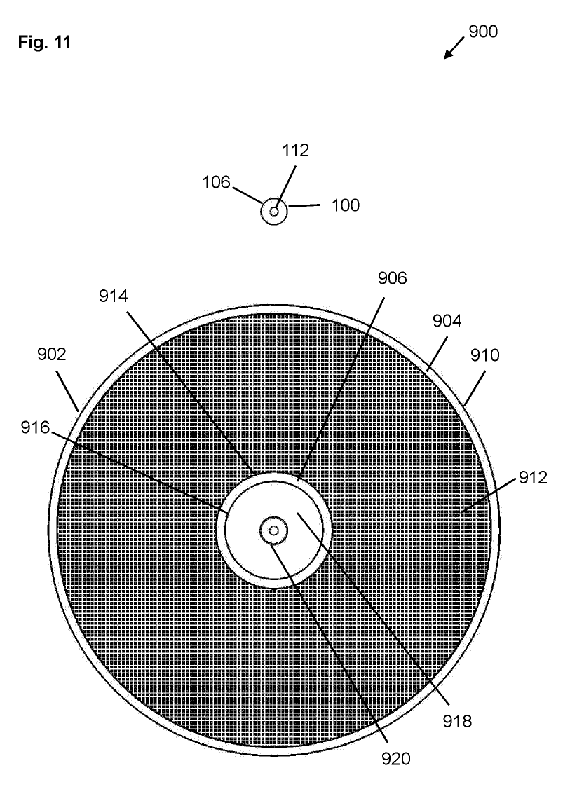

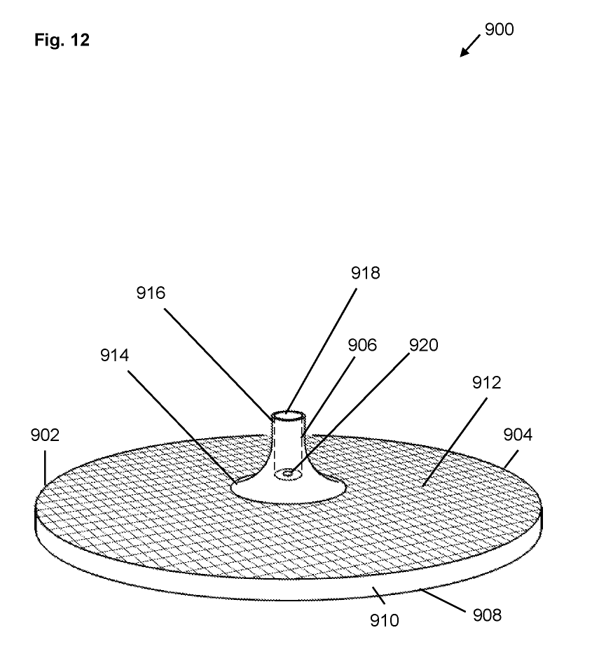

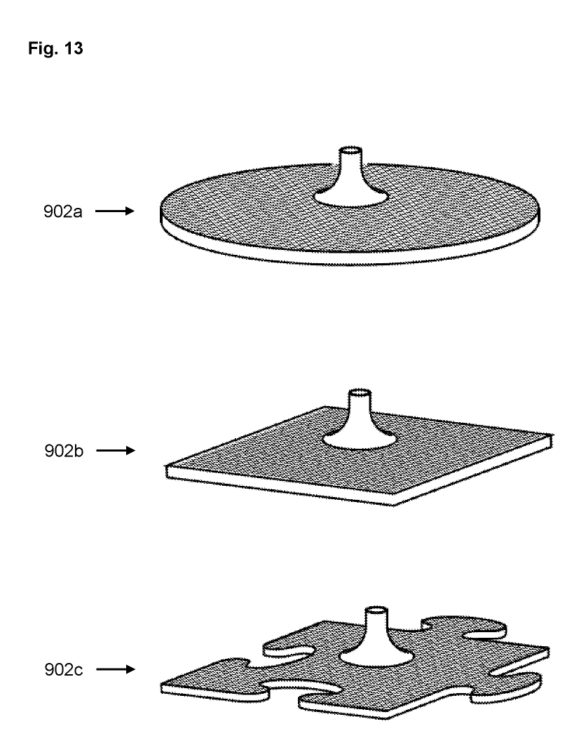

FIG. 9 shows a perspective view of an embodiment of a solar-powered assembly according to this disclosure. FIG. 9a shows a cross-sectional view of an embodiment of a well of a solar-powered assembly according to this disclosure. FIG. 9b shows a cross-sectional view of an embodiment of a well of a solar-powered assembly according to this disclosure. FIG. 10 shows a schematic view of an embodiment of a solar-powered assembly according to this disclosure. FIG. 11 shows a top view of an embodiment of a solar-powered assembly according to this disclosure. FIG. 12 shows a perspective view of an embodiment of a photovoltaic base according to this disclosure. FIG. 13 shows a perspective view of a plurality of embodiments of a plurality of photovoltaic bases according to this disclosure. A solar-powered assembly 900 comprises a base 902 comprising a disk 904 and a funnel-shaped bulb receiver 906. The receiver 906 is coupled to the disk 904, such as via fastening, adhering, mating, or other coupling techniques.

The disk 904 is solid, but can be perforated. The disk 904 is cylindrical and circular, but can be shaped differently, such as square, an oval, a triangle, a star, a pentagon, a trapezoid, or other closed or polygonal shape. For example, as shown in FIG. 13, in a base 902a, the disk 904 is circular. Likewise, in a base 902b, the disk 904 is square. Similarly, in a base 902c, the disk 904 is jigsaw tile shaped (or any type of a tile that may be oddly shaped or structured to interlock or to tessellate). Note that a photovoltaic array can be assembled via a plurality of bases 902c.

The disk 904 comprises a lower base 908, a sidewall 910, and an upper base 912. The sidewall 910 spans between the base 908 and the base 912. The base 912 comprise an array of photovoltaic cells, which are structured to absorb a light, whether indoors or outdoors, and convert the light into an electric current, such as with a direct voltage (DC). For example, the base 902 may comprise an inverter to convert the DC current into an alternating current (AC). The cells may be of any type, such as a crystalline silicon type, a thin-film type, a cadmium telluride type, a copper indium gallium selenide type, a silicon thin film type, a gallium arsenide thin film type, a multi-junction cell type, a perovskite solar cell type, or others. The base 912 may be covered with a weatherproof or dustproof coating, such as for use during camping or rough environments. For example, the weatherproof coating may repel or resist water, such as rain.

In some embodiments, the disk 904 may comprise a support pedestal or a plurality of legs to raise the disk 904 from a ground surface, such as for a ground clearance. In some embodiments, the disk 904 may be suspended via a rope/cable/wire extending therefrom, whether elastic or non-elastic, or hung on a surface, as a painting, such as on a wall, such as via a hook or a tab extending therefrom.

The receiver 906 comprises a base 914, a stem 916, a conductive wire 922, and an electric circuit board 924. The base 914 is supported via and extends from the disk 904. Although the base 914 is circular, other shapes are possible, such as square, an oval, a triangle, a star, a pentagon, a trapezoid, or other closed or polygonal shape. The base 914 and the stem 916 are unitary, but can be assembled with each other. The board 924 is electrically coupled to the disk 904 and the wire 922. The board 924 is designed to facilitate a flow of an electric current from the photovoltaic cells to the wire 922. For example, the board 924 may comprise an inverter to convert a DC current from the photovoltaic cells into an AC current. For example, the board 924 may comprise a battery or a capacitor to store a DC current. The receiver 906 comprises an electrically insulating material, whether identical to or different from each other, such as a porcelain, a glass, a rubber, a wood, a plastic, a fiberglass, a ceramic, a quartz, a polymer, a composite, or others. In some embodiments, the disk 904 supports at least two receivers 906, such as at a 3 o'clock position and a 9 o'clock position.

The stem 916 is elongated, rectilinear, diametrically uniform, and perpendicular to the disk 904. However, note that the stem 916 can be non-rectilinear, such as arcuate, sinusoidal, or others. Likewise, note that the stem 916 can be diametrically varying. Similarly, note that the stem 916 can be non-perpendicular to the disk 904, such as acute or obtuse. In some embodiments, at least two stems 916 extend from the base 914, whether opposing or adjacent to each other.

The stem 916 is rigid, but can be flexible or elastic. For example, the stem 916 can be biased with a spring or an elastic member housed within the base 914 or the disk 904. Likewise, the stem 916 can comprise a memory foam or a memory plastic/polymer. Therefore, the stem 916 can be moved around or bent to orient the light bulb 100 in a specific direction.

The stem 916 comprises a top portion, which defines a well 918 into the stem 916. The well 918 is cylindrical with a circular cross-section, although other cross-sectional shapes are possible, such as square, an oval, a triangle, a star, a pentagon, a trapezoid, or other closed or polygonal shape. The well 918 comprises a base comprising a male portion 920. The wire 922 is electrically coupled to the portion 920 and the board 924. For example, the portion 922 is electrically coupled to the wire 922 to receive an electric current from the wire 922, which may be sourced from the photovoltaic cells. The portion 920 is configured for an electrical mating with the portion 112 of the light bulb 100, such as to conduct an electrical current for the light source. Although the portion 920 is circular, other shapes are possible, such as square, an oval, a triangle, a star, a pentagon, a trapezoid, or other closed or polygonal shape. In some embodiments, the base of the well 918 comprises a female portion configured for an electrical mating with a male portion, such as to conduct an electrical current for the light source. As shown in FIG. 9a, the well 918 comprises a conductor 921 enclosing the portion 920, yet spaced apart from the portion 920 via an insulator 917 in order to create an electric current loop. For example, the conductor 921 can be ground and the portion 920 can be live. Similarly, as shown in FIG. 9b, the well 918 comprises a conductor 923 enclosing the portion 920, yet spaced apart from the portion 920 via an insulator 919 in order to create an electric current loop. For example, the conductor 923 can be ground and the portion 920 can be live.

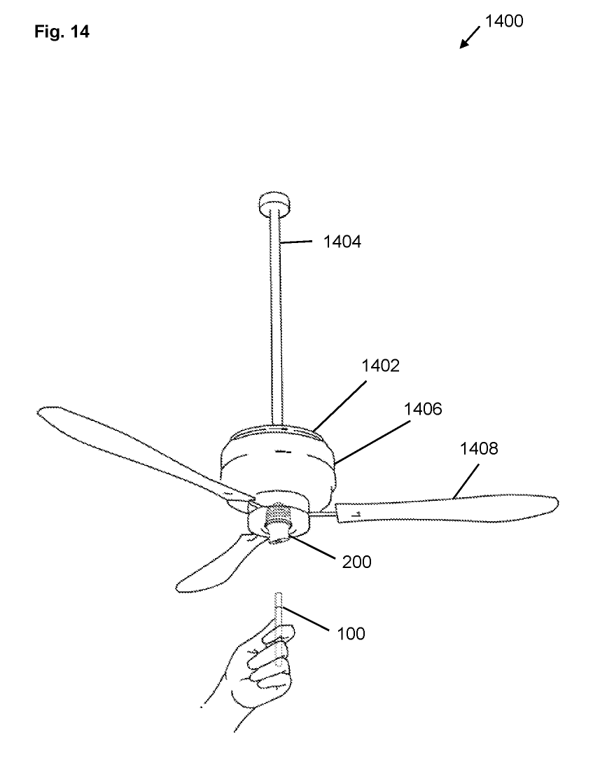

FIG. 14 shows a perspective view of an embodiment of a light fixture structured to receive a light bulb according to this disclosure. A light fixture 1400 comprises a ceiling fan 1402 and a bar 1404.

The fan 1402 is coupled to the bar 1404, such as via fastening, adhering, mating, or other coupling techniques. The fan 1402 comprises an electric motor powered via an electric current. The fan 1402 comprises a plurality of blades/foils 1408, which rotate about a vertical axis, which may be co-axial to a longitudinal axis of the bar 1404. The fan 1402 comprises a bulb socket of the screw 202, i.e., the wall 204, as disclosed herein. The wall 204 is integrated/built-in into the fan 1402.

The bar 1404 is structured to secure to a ceiling, such as via coupling, adhering, mating, or other coupling techniques. For example, the bar 1404 spans between the ceiling and the fan 1402. The bar 1404 comprises a conductive wire running therethrough, where the wire extends between the ceiling and the fan 1402, such as from the ceiling into the fan 1402. The conductive wire is used to conduct an electric current, such as an AC current, to the motor, such as to rotate the blades/foils 1408, and to the wall 204, such as to conduct an AC current to the portion 208 via the wire 210. Note that the bar 1404 is rigid to minimize a wobbling movement of the fan 1402 when the fan 1402 rotates the blades/foils 1408. Therefore, since the well 206 comprises the portion 208 and the portion 208 is configured for an electrical mating with the portion 112, such as to conduct an electrical current for the light source, the light bulb 100 can be coupled to the well 206, including electrically and mechanically, such as via a manual insertion of the light bulb 100 into the well 206 such that the portion 112 contacts and mates with the portion 208, or vice versa. In some embodiments, the fan 1402 is lacking and the bar 1404 comprises the bulb socket of the screw 202, i.e., the well 206, as disclosed herein, is integrated/built-in into the bar 1404 and powered via the conductive wire running through the bar 1404. In some of such embodiments, the bar 1404 can be rigid or flexible/elastic. In some of such embodiments, the bar 1404 is replaced with a chain.

FIG. 15 shows a perspective view of an embodiment of a light fixture structured to receive an Edison base, where the Edison base is structured to receive a light bulb according to this disclosure. A light fixture 1500 comprises a ceiling fan 1502 and a bar 1504.

The fan 1502 is coupled to the bar 1504, such as via fastening, adhering, mating, or other coupling techniques. The fan 1502 comprises an electric motor powered via an electric current. The fan 1502 comprises a plurality of blades/foils 1508, which rotate about a vertical axis, which may be co-axial to a longitudinal axis of the bar 1504.

The fan 1502 comprises a standardized bulb socket, such as an Edison screw-type bulb socket, which is structured to receive the base 200, as disclosed herein. For example, the screw 202 can thread into the Edison-screw type bulb socket such that the tip 214 contacts a base of the Edison screw-type bulb socket and is able to receive an electric current therefrom.

The bar 1404 is structured to secure to a ceiling, such as via coupling, adhering, mating, or other coupling techniques. For example, the bar 1404 spans between the ceiling and the fan 1402. The bar 1404 comprises a conductive wire running therethrough, where the wire extends between the ceiling and the fan 1402, such as from the ceiling into the fan 1402. The conductive wire is used to conduct an electric current, such as an AC current, to the motor, such as to rotate the blades/foils 108, and to the standardized bulb socket, such as to conduct an AC current to the base of the Edison screw-type bulb socket. Note that the bar 1404 is rigid to minimize a wobbling movement of the fan 1402 when the fan 1402 rotates the blades/foils 1408.

Therefore, the base 200 is fastened into the standardized bulb socket such that the tip 214 receives an electric current from the base of the standardized bulb socket and such that the electric current is conducted via the wire 210 to the portion 208. Subsequently, the light bulb 100 is coupled to the well 206 such that the portion 208 electrically mates with the portion 112, such as to conduct an electrical current for the light source. For example, the light bulb 100 can be coupled to the well 206, including electrically and mechanically, such as via a manual insertion of the light bulb 100 into the well 206 such that the portion 112 contacts and mates with the portion 208, or vice versa. In some embodiments, the light bulb 100 is coupled to the base 200 and then the base 200 is coupled to the standardized bulb socket.

In some embodiments, the fan 1502 is lacking and the bar 1504 comprises the standardized bulb socket, such as when the standardized bulb socket is integrated/built-in into the bar 1504 and powered via the conductive wire running through the bar 1504. In some of such embodiments, the bar 1504 can be rigid or flexible/elastic. In some of such embodiments, the bar 1504 is replaced with a chain.

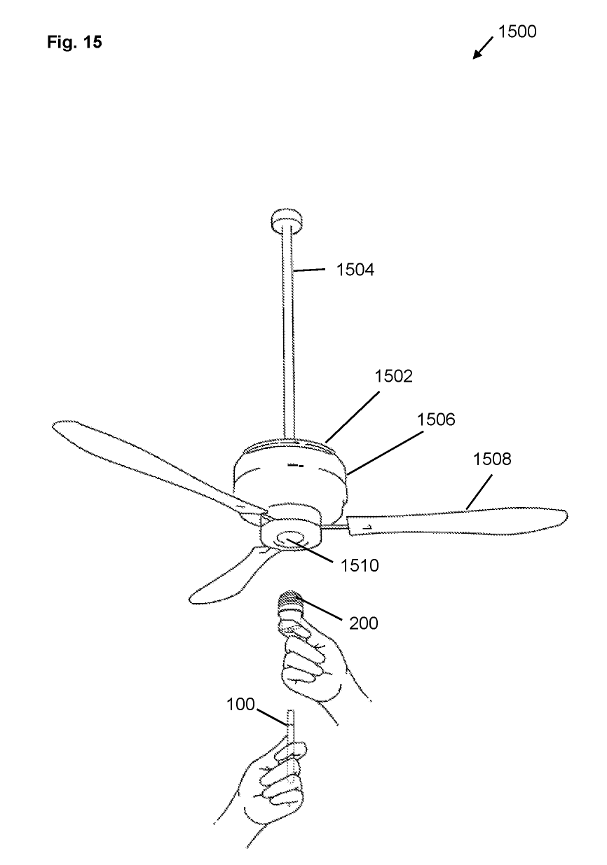

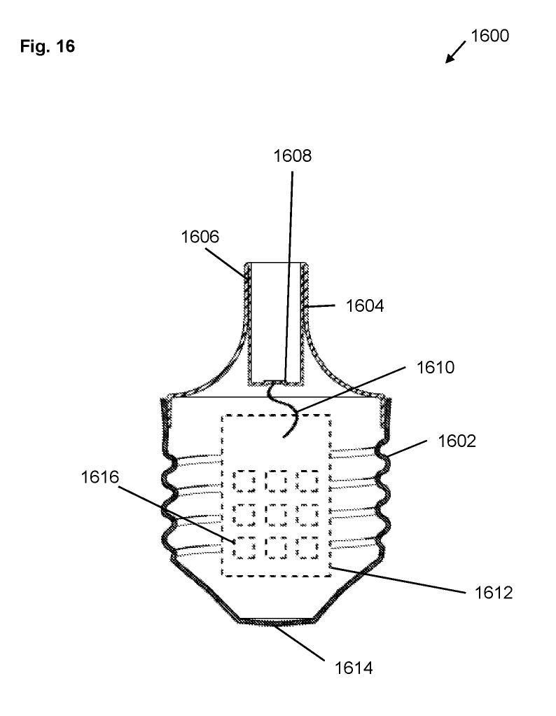

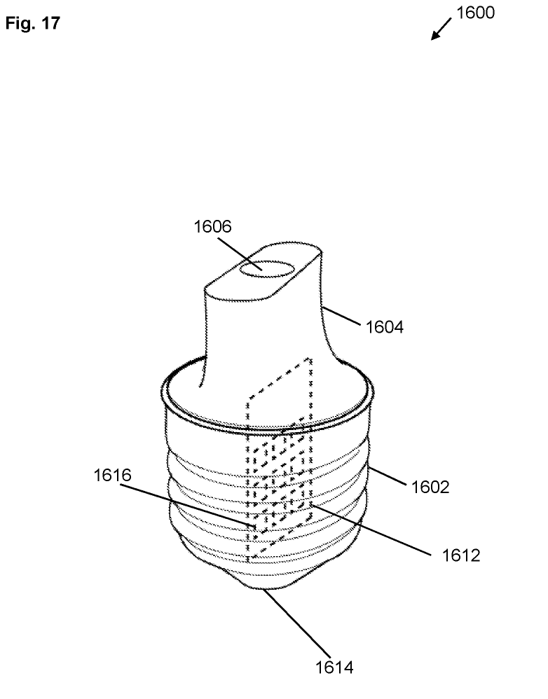

FIG. 16 shows a schematic view of an embodiment of an Edison base comprising a sensor or a transmitter according to this disclosure. FIG. 17 shows a perspective view of an embodiment of an Edison base comprising a sensor or a transmitter according to this disclosure. An Edison base 1600 comprises an Edison screw 1602 and a wall 1604, as disclosed herein. The screw 1602 is threaded, whether right-hand or left-hand, for an installation into a bulb socket, such as an Edison socket, in order to receive an electric current from the bulb socket for the light source. The screw 1602 comprises a conductive wire 1610, an electric circuit board 1612, and a tip 1614. The board 1612 is electrically coupled to the tip 1614 and the wire 1610. The tip 1614 is structured to receive an electric current from a bulb socket, such as a standardized bulb socket, when the screw 1602 is installed into the bulb socket. The board 1612 is designed to facilitate a flow of an electric current from the tip 1614 to the wire 1610.

The board 1612 also hosts a module 1616. The module 1616 can comprise a processing unit, a memory unit, a sensing unit, a communication unit, a light control unit, or others, whether as a single unit or a plurality of units, such as a sound generation unit, such as a transducer, such as a speaker.

In some embodiments, the board 1612 may comprise, whether as a single module or a plurality of modules, a processing module 1616P, a memory module 1616M, a sensing module 1616S, a communication module 1616C, and a light control module 1616L. The processing module 1616P is communicably coupled to the memory module 1616M, the sensing module 1616S, the communication module 1616C, and the light control module 1616L, such as via a system bus, which may be powered via a power source, whether on-board, such as a battery, which may be rechargeable, or whether via the tip 214, such as from a mains electricity wire.

The processing module 1616P can comprise a processor, such as a microprocessor, whether single or multi-core. The processing module 1616P can be powered via a power source, whether on-board, such as a battery, which may be rechargeable, or whether via the tip 214, such as from a mains electricity wire.

The memory module 1616M can comprise a memory chip, whether volatile or non-volatile, such as a flash memory. The memory module 1616M can be powered via a power source, whether on-board, such as a battery, which may be rechargeable, or whether via the tip 214, such as from a mains electricity wire. The memory module 1616M stores a set of instructions executable via the processing module 1616P. The set of instructions can include a machine code, an object code, a source code, or others. The set of instructions can be written or sourced from a programming language, such as C++, Java, Python, or others.

The sensing module 1616S can comprise a sensor, which can be active or passive, whether mechanical or electronic. The sensing module 1616S can be powered via a power source, whether on-board, such as a battery, which may be rechargeable, or whether via the tip 214, such as from a mains electricity wire. The sensor can be configured to detect or to respond to an input from a physical environment. For example, the input can be at least one of light, heat, motion, moisture, humidity, sound, electricity, pressure, smoke, gas, or any other environmental aspect/parameter. The sensor can provide an output, such as a signal, whether a mechanical (a sound or a vibration) or electrical signal (a pulse or a burst). The sensor can be powered via a power source, whether on-board, such as a battery, or whether via the tip 214, such as from a mains electricity wire. For example, the sensor can comprise a thermometer, a barometer, a moisture/humidity sensor, a particle sensor, a light sensor, a water sensor, a motion sensor, a proximity sensor, a sound sensor, a smoke detector, a carbon monoxide detector, a gas leakage detector, a harmful/toxic liquid/gas sensor, or others.

The communication module 1616C can comprise a receiver, a transmitter, or a transceiver configured for a wireless or wired signal communication. The communication module 1616C can be powered via a power source, whether on-board, such as a battery, which may be rechargeable, or whether via the tip 214, such as from a mains electricity wire. The signal communication can be over short distance or long distance, whether direct or indirect, whether indoors or outdoors. For example, the signal communication can comprise an infrared signal, a radio frequency signal, an optical signal, a sound signal, or others. For example, the radio frequency signal can comprise a Wi-Fi signal, a Bluetooth signal, an RFID signal, a cellular signal, or a GPS signal. For example, the optical signal comprise a laser or a light wave.

The light control module 1616L can comprise a circuit programmed to take a light control action. Such action can include a light turn-on/off, a light intensity increase/decrease, a light color change, a light tone change, a light flash-on/off, or any other light property.

In some embodiments, the base 1600 can be used as an Internet of Things (IOT) device, where the base 1600 can be communicably accessed locally or remotely, such as for use, control, maintenance, or updates. Such communicable access can be via the communication module 1616C communicating with a device, such as a laptop, a desktop, a wearable (bracelet/clothing/jewelry), a tablet, a vehicle, a sensor, an appliance (kitchen/bathroom/industrial), a smartphone, a router, or others. Such communication can be wirelessly direct, such as via a Bluetooth signal or an infrared signal. Such communication can be wirelessly indirect, such as via a Wi-Fi signal over a network router or a cellular signal via a cellular base station. Such communication can be wired, such as over a power-line signal over a power-line, such as an aluminum or copper power-line, via the tip 1614. For example, in response to the communication module 1616C receiving a signal from a device, such as a laptop, a desktop, a wearable (bracelet/clothing/jewelry), a tablet, a vehicle, a sensor, an appliance (kitchen/bathroom/industrial), a smartphone, a router, or others, the communication module 1616C sends the signal to the processing module 1616P. In response, the processing module 1616P reads the set of instructions from the memory module 1616M and requests that an action be taken or not taken based on the signal, such as via the light control module 1616L. Therefore, for example, a user can operate a smartphone to access the base 1600 over a Wi-Fi or cellular signal via the communication module 1616C and control the light bulb 100 coupled to the base 1600 via the processing module 1616P and the light control module 1616L, such as to take a light control action, as disclosed herein.

In some embodiments, in response to the sensing module 1616P sensing an input from a physical environment, the sensing module 1616P provides an output to the processing module 1616P. In response, the processing module 1616P reads the set of instructions from the memory module 1616M and requests that the communication module 1616C sends the output to a device, whether in a wired manner or a wireless manner, whether directly or indirectly, to a device, such as a laptop, a desktop, a wearable (bracelet/clothing/jewelry), a tablet, a vehicle, a sensor, an appliance (kitchen/bathroom/industrial), a smartphone, a router, or others. For example, the base 1600 can comprise the sensing module 1616S can comprise a smoke or carbon monoxide sensor and the base 1600 can be used as a smoke or carbon monoxide detector and notify a device if a smoke or carbon monoxide is detected.

The wall 1604 extends from the screw 1602. The wall 1604 is coupled to the screw 1602, such as via fastening, adhering, mating, or other coupling techniques. The wall 1604 is solid, but can be perforated. The wall 1604 comprises an electrically insulating material, whether identical to or different from each other, such as a porcelain, a glass, a rubber, a wood, a plastic, a fiberglass, a ceramic, a quartz, a polymer, a composite, or others. The wall 1604 comprises a top portion, which defines a well 1606 into the wall 1604. The well 1606 is cylindrical with a circular cross-section, although other cross-sectional shapes are possible, such as square, an oval, a triangle, a star, a pentagon, a trapezoid, or other closed or polygonal shape. The well 1606 comprises a base comprising a male portion 1608. The portion 1608 is electrically coupled to the wire 1610, such as to receive an electric current from the wire 1610. The portion 1608 is configured for an electrical mating with the portion 112, such as to conduct an electrical current for the light source. Although the portion 1608 is circular, other shapes are possible, such as square, an oval, a triangle, a star, a pentagon, a trapezoid, or other closed or polygonal shape. In some embodiments, the base of the well 1606 comprises a female portion configured for an electrical mating with a male portion, such as to conduct an electrical current for the light source.

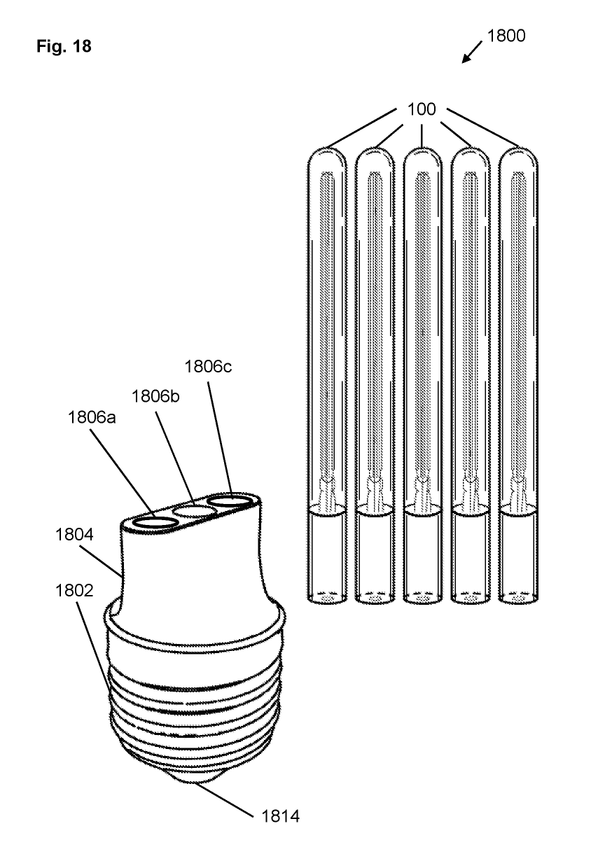

FIG. 18 shows a perspective view of an embodiment of an Edison base structured to receive a plurality of light bulbs according to this disclosure. An Edison base 1800 include a screw 1802 and a wall 1804, as disclosed herein. The wall 1804 extends from the screw 1802. The wall 1804 is coupled to the screw 1802, such as via fastening, adhering, mating, or other coupling techniques. The wall 1804 is solid, but can be perforated. The wall 1804 comprises an electrically insulating material, whether identical to or different from each other, such as a porcelain, a glass, a rubber, a wood, a plastic, a fiberglass, a ceramic, a quartz, a polymer, a composite, or others.

The wall 1804 comprises a top portion, which defines a plurality of wells 1806a, 1806b, 1806c into the wall 1804. Note that although three of the wells 1806 are shown, the wall 1804 comprises at least two of the wells 1806 and more than three of the wells 1806 can be used, such as five or twenty.

Each of the wells 1806a, 1806b, 1806c is cylindrical with a circular cross-section, although other cross-sectional shapes are possible, such as square, an oval, a triangle, a star, a pentagon, a trapezoid, or other closed or polygonal shape. At least two of the wells 1806a, 1806b, 1806c may be similarly shaped, sized, powered, controlled, or structured or dissimilarly shaped, sized, powered, controlled, or structured in any manner, such as height, diameter, volume, voltage, amperage, wattage, or others. At least two of the wells 1806a, 1806b, 1806c can be jointly controlled or at least two of the wells 1806a, 1806b, 1806c can be individually controlled. For example, a first light action may control at least one of the wells 1806a, 1806b, 1806c and a second light action may control at least one of the wells 1806a, 1806b, 1806c, whether the first light action and the second light action are a single light action or distinct light actions. Note that such action can include a light turn-on/off, a light intensity increase/decrease, a light color change, a light tone change, a light flash-on/off, or any other light property.

Each of the wells 1806a, 1806b, 1806c comprises a base comprising a male portion 1808. The portion 1808 is electrically coupled to a wire 1810, such as to receive an electric current from the wire 1810. The portion 1808 is configured for an electrical mating with the portion 112, such as to conduct an electrical current for the light source. Although the portion 1808 is circular, other shapes are possible, such as square, an oval, a triangle, a star, a pentagon, a trapezoid, or other closed or polygonal shape. In some embodiments, the base of at least one of the wells 1806a, 1806b, 1806c comprises a female portion configured for an electrical mating with a male portion, such as to conduct an electrical current for the light source. In some embodiments, the wall 1804 comprises a single well 1806, yet the bulb 100 is tree-shaped, such when at least one of the platform/base 102, the casing 104, or at least one of the filament 120 branch. For example, a single platform/base 102 may function as a stem from which a plurality of casings 104/filaments 120 branch.

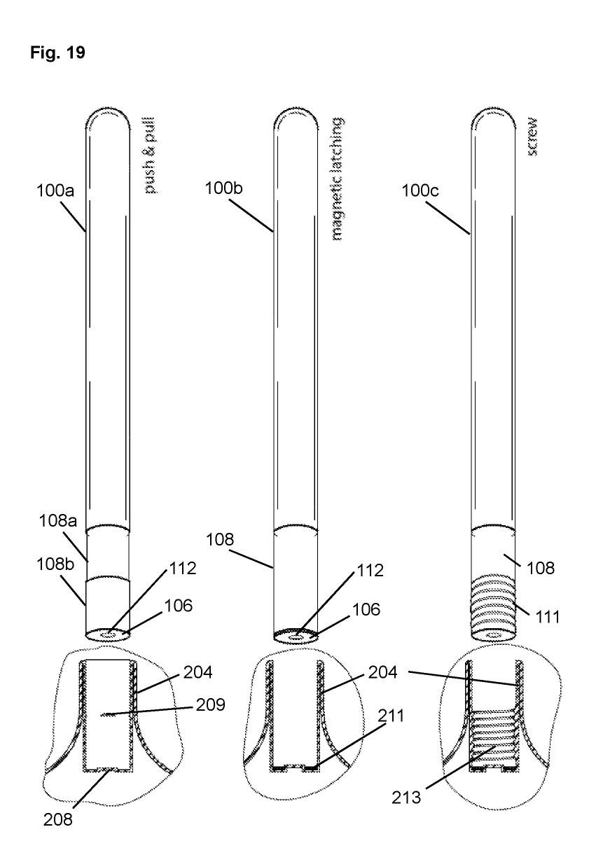

FIG. 19 shows a perspective view of a plurality of embodiments of a plurality of light bulb coupling mechanisms according to this disclosure. A light bulb 100a comprises the sidewall 108 comprising a first sidewall portion 108a and a second sidewall portion 108b, which have varying diameters and have equal heights, although variations are possible. The wall 204 comprises the well 206 comprising a tab 209 above the portion 208. The tab 209 protrudes outwardly into the wall 206 and is thereby able to engage/mate/mesh with at least one of the first sidewall portion 108a or the second sidewall portion. Therefore, the bulb 100a is able to removably couple to the base 200 in a push/pull manner such that the portion 112 can mate with the portion 208.

A light bulb 100b comprises the base 106. The base of the well 206 comprises a an area 211, which may be open-shaped or closed-shape, enclosing the portion 208, or vice versa. The area 211, such as via comprising a magnet, and the base 106, such as via comprising a magnetically attractive metal, are configured for a magnetic attachment, or vice versa. Therefore, the bulb 100b is able to removably couple to the base 200 in a magnetic manner such that the portion 112 can mate with the portion 208.

A light bulb 100c comprises the sidewall 108 comprising a plurality of first threads 111, whether right-handed or left-handed. The well 206 comprises a plurality of second threads 213, whether right-handed or left-handed. The first threads mate/engage/mesh/fasten with the second threads 213. Therefore, the bulb 100c is able to removably couple to the base 200 in a fastening manner such that the portion 112 can mate with the portion 208.

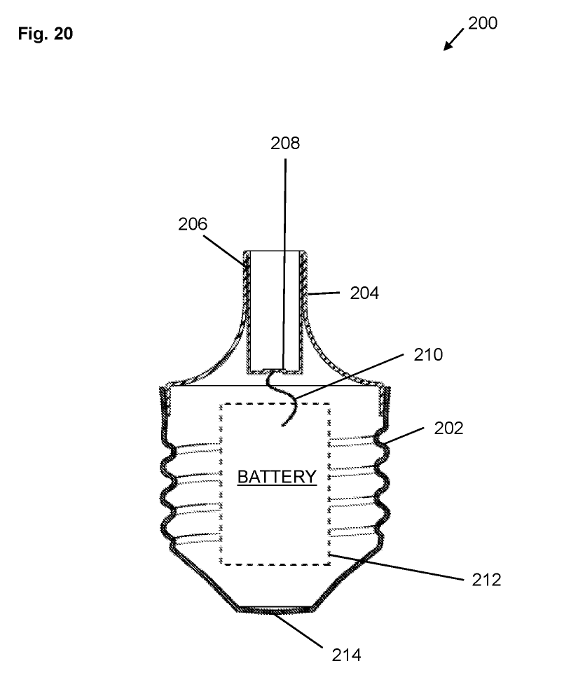

FIG. 20 shows a schematic view of an embodiment of an Edison base with a battery according to this disclosure. Whether additional or alternative to the board 212, the base 200 can comprise a battery, such as a cadmium or a lithium ion battery, which may be rechargeable. For example, the battery can be cylindrical or button-shaped. For example, the battery can be electrically coupled to the tip 214 and the wire 210, such as opposing poles, such as for recharging or passing through an electrical current, since the tip 214 is structured to receive an electric current from a bulb socket when the screw 202 is installed into the bulb socket. Whether additional or alternative to the battery, the base 200 can comprise a capacitor.

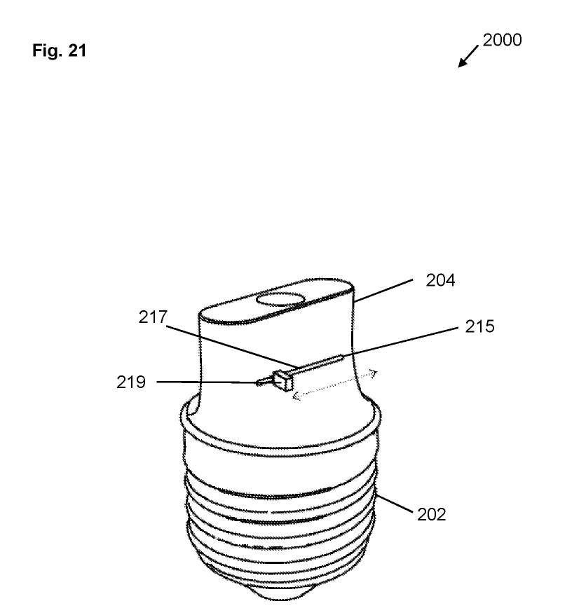

FIG. 21 shows a perspective view of an embodiment of an Edison base with a light property control element according to this disclosure. The base 200 comprises the screw 202 and the wall 204. The wall 204 comprises a gradual level selector 215 comprising a scale 217 and a tab 219 coupled to the scale 217 such that a degree of a property/characteristic/aspect can be manually changed or modified. Some examples of the selector 215 are disclosed in U.S. Pat. Nos. and U.S. Patent Application Publications 5,008,865, 7,535,443, 8,096,674, 9,326,362, 20030057879, and 20080143272, each of which is fully incorporated by reference herein for all purposes. For example, the degree may be of an output, such as a light, a sound, a vibration, or others. For example, the degree of the light may be brightness, color, intensity, flashing, on/off, or others. For example, when the bulb 100 is coupled to the base 200, then the degree of the light from the bulb 100 may be controlled via sliding the tab 219 along the scale 217 between a pair of end points of the scale 217. Note that although the selector 215 is a slider, other types of gradual level selectors 215 can be used, whether on a single side of the wall 204 or a plurality of sides of the wall 204, such as a knob or a dial coupled to the wall 204 and rotating about a horizontal axis to gradually select a level, or one or more buttons coupled to the wall 204 that can be pressed to gradually select a level, as disclosed herein.

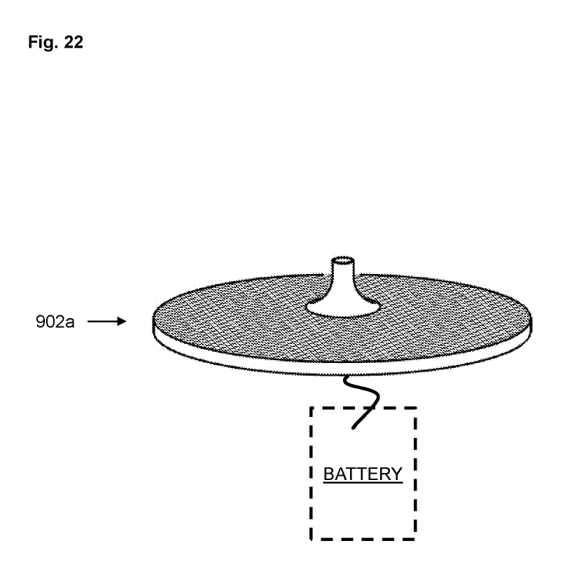

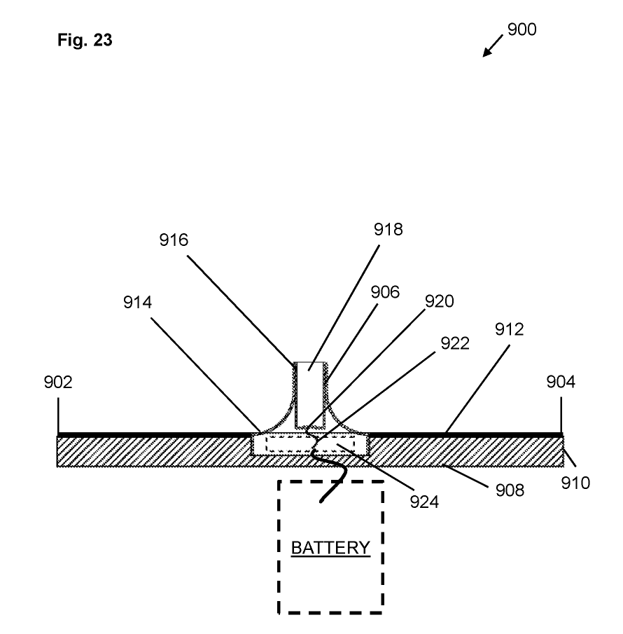

FIG. 22 shows a perspective view of an embodiment of a photovoltaic base electrically coupled to a battery according to this disclosure. FIG. 23 shows a schematic view of an embodiment of a photovoltaic base electrically coupled to a battery according to this disclosure. As disclosed herein, the assembly 900 comprises the base 902 comprising the disk 904 and the receiver 906, where the receiver 906 is coupled to the disk 904, such as via fastening, adhering, mating, or other coupling techniques.

Whether additional or alternative, the board 924 is coupled to a battery, such as via a conductive wire. The battery can be of any type, such as a cadmium or a lithium ion battery, which may be rechargeable. For example, the battery can be cylindrical or button-shaped. For example, the battery can be used to store a DC current obtained from the photovoltaic cells of the base 912.

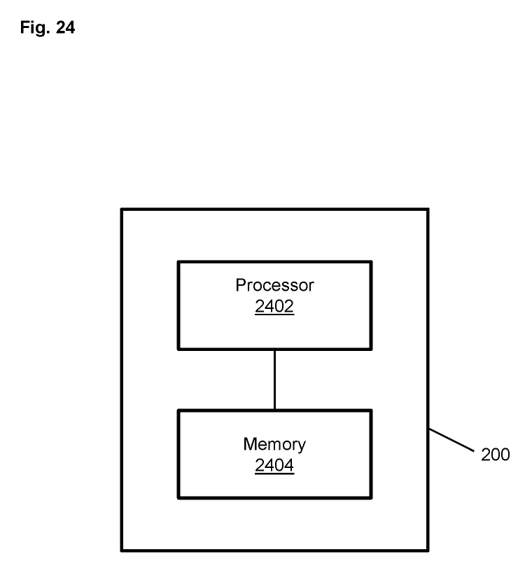

FIG. 24 shows a schematic view of an embodiment of a self-learning battery management system according to this disclosure. Whether additional or alternative to the module 1600, the base 200 comprises a processor 2402 and a memory 2402, which may be hosted on the board 1612, which may function as a system bus. The processor 2402 is coupled to the memory 2402, such as via a system bus, which may be powered via a power source, whether on-board, such as a battery, which may be rechargeable, or whether via the tip 214, such as from a mains electricity wire.

The processor 2402 can comprise a processor, such as a microprocessor, whether single or multi-core. The processor 2402 can be powered via a power source, whether on-board, such as a battery, which may be rechargeable, or whether via the tip 214, such as from a mains electricity wire.

The memory 2404 can comprise a memory chip, whether volatile or non-volatile, such as a flash memory. The memory 2404 can be powered via a power source, whether on-board, such as a battery, which may be rechargeable, or whether via the tip 214, such as from a mains electricity wire. The memory 2404 stores a set of instructions executable via the processor 2402. The set of instructions can include a machine code, an object code, a source code, or others. The set of instructions can be written or sourced from a programming language, such as C++, Java, Python, or others.

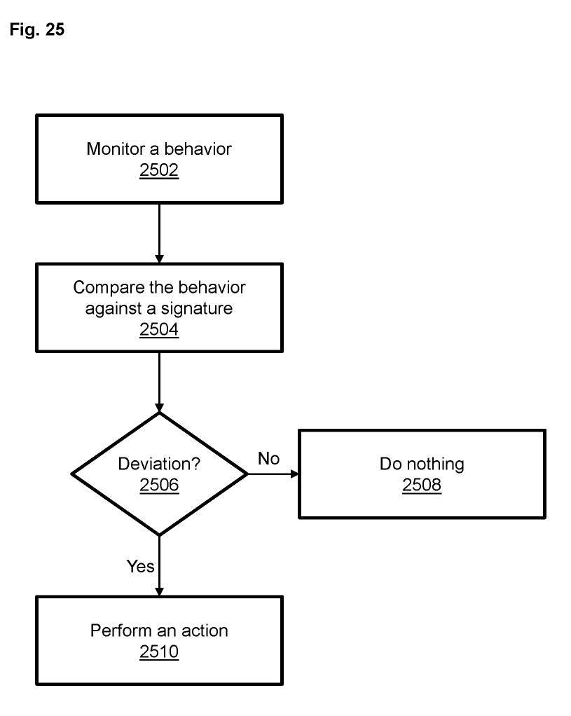

FIG. 25 shows a flowchart of an embodiment of a process for self-learning battery management according to this disclosure. This process may be coded via the set of instructions for execution via the processor 2404. This process comprises a plurality of blocks 2502-2510.

In a block 2502, the processor 2404 monitors a behavior of the base 200, such as via continuously or periodically tracking an electric current or a characteristic/aspect/property thereof, such as voltage, amperage, or others, as being provided to the bulb 100 or received via the tip 214. Additionally or alternatively, the behavior may comprise a light output, i.e., the processor may monitor a light output or a characteristic/aspect/property thereof, as output from the bulb 100 via the base 200. For example, the behavior can be recorded as an event entry in a log stored in the memory 204. Such monitoring can be similar to a security program continuously or periodically monitoring a computer behavior.

In a block 2502, the processor 2404 compares the behavior against a signature stored in the memory 2404. For example, the event entry is compared against the signature, such as via a data point.

In a block 2504, the processor 2404 decides whether a deviation has occurred, i.e., whether the behavior deviates from the signature. If not, then the processor 2404 performs a block 2508. Otherwise, the processor 2404 performs a block 2508, where the processor performs an action. Such action can include a light turn-on/off, a light intensity increase/decrease, a light color change, a light tone change, a light flash-on/off, or any other light property, which may extend a charge of the battery. Note that this process is an example and other processed may be used, whether additionally or alternatively. Some examples of a process for self-learning battery management according are disclosed in U.S. Pat. Nos. and U.S. Patent Application Publications 6,635,974, 8,350,529, 8,719,195, and 20130207613, each of which is fully incorporated by reference herein for all purposes.

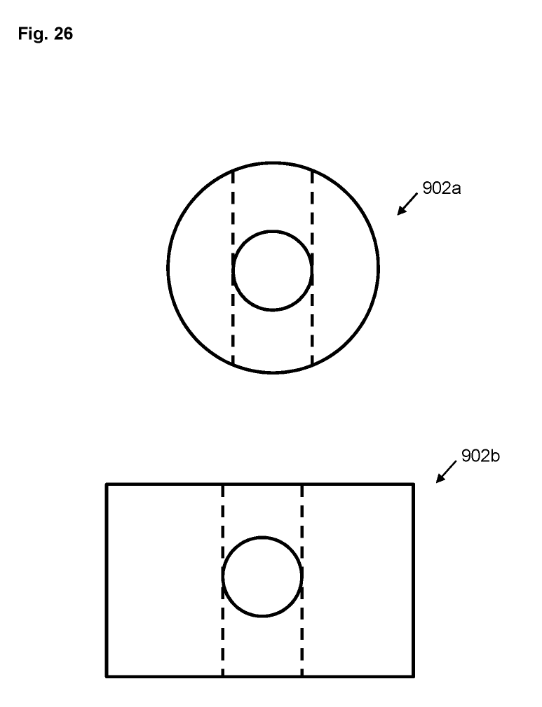

FIG. 26 shows a schematic diagram of a plurality of embodiments of a plurality of fold lines for a plurality of photovoltaic bases according to this disclosure. In the base 902a, the disk 904 is circular. Likewise, in the base 902b, the disk 904 is square.

The disk 904 comprises a plurality of fold lines enclosing a central portion of the disk 904, where the central portion supports the receiver 906. The fold lines are tangent to the central portion such that a U-shape is formed when the disk 904 is folded according to the fold lines toward a common point or a N-shape when the disk 904 is folded according to the fold lines toward two different points on opposing sides of the disk 904.

FIG. 27 shows a perspective view of an embodiment of a flashlight comprising a light bulb according to this disclosure. A flashlight 2700 comprises a handle 2702 and a light emitting portion 2704 comprising the bulb 100.

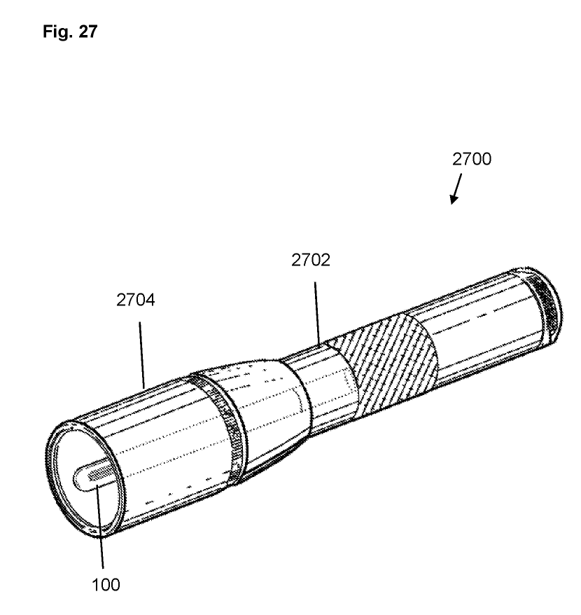

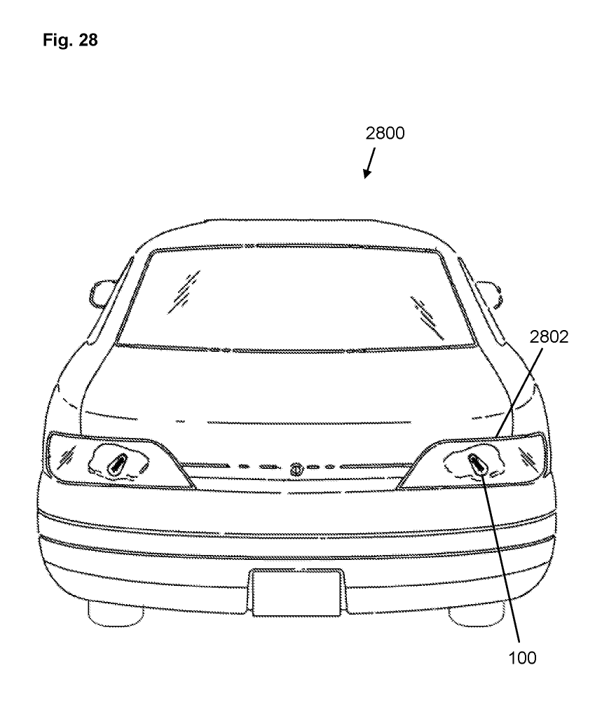

FIG. 28 shows a perspective view of an embodiment of a vehicle comprising a light bulb according to this disclosure. A car 2800 comprises a headlight 2802 comprising the bulb 100. Note that although the car 2800 is shown, any type of vehicle can be used, such as land, aerial, marine, or space. For example, a vehicle can comprise a van, bus, motorcycle, bicycle, skateboard, tractor, tank, truck, hovercraft, boat, ship, submarine, jet ski, trailer, airplane, helicopter, or any others, whether manned or unmanned.

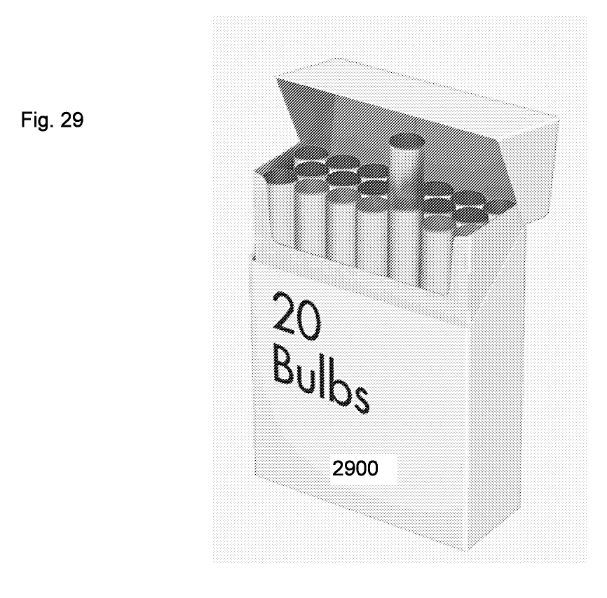

FIG. 29 shows a cross-sectional view of a container storing a plurality of light bulbs according to this disclosure. A container 2900 stores a plurality of bulbs 100, as disclosed herein.

FIG. 30 shows a perspective view of an embodiment of an adapter and a light bulb coupled thereto and a solar-powered lantern according to this disclosure. An on-the-grid configuration 3000a comprises the base 200 and the bulb 100 coupled thereto, as disclosed herein. An off-the-grid configuration 3000b comprises various solar-powered lanterns, as disclosed herein, such as the base 900.

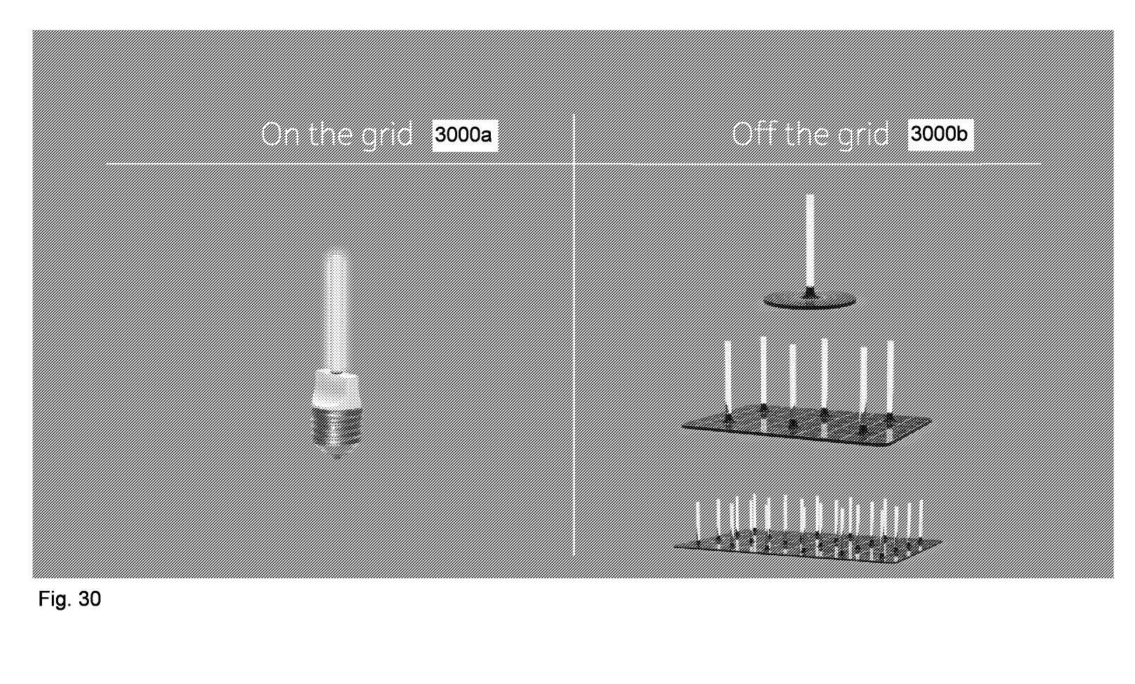

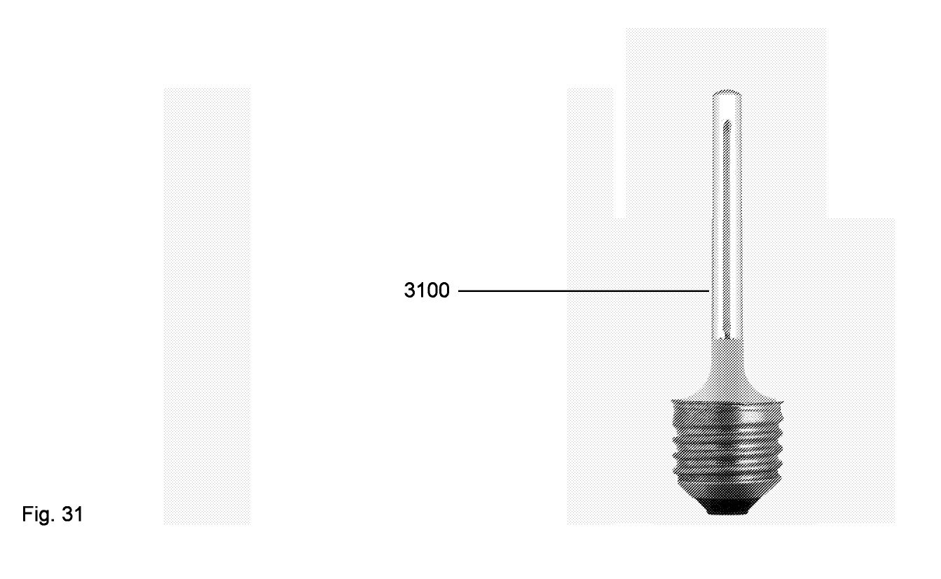

FIG. 31 shows a side view of an embodiment of an illumination device according to this disclosure. An illumination device 3100 comprises the bulb 100 and the base 200, as disclosed herein. Note that the bulb 100 and the base 200 can be a single unit, as disclosed herein. However, in other embodiments, the bulb 100 and the base 200 are distinct units and can be coupled to each other, as disclosed herein.

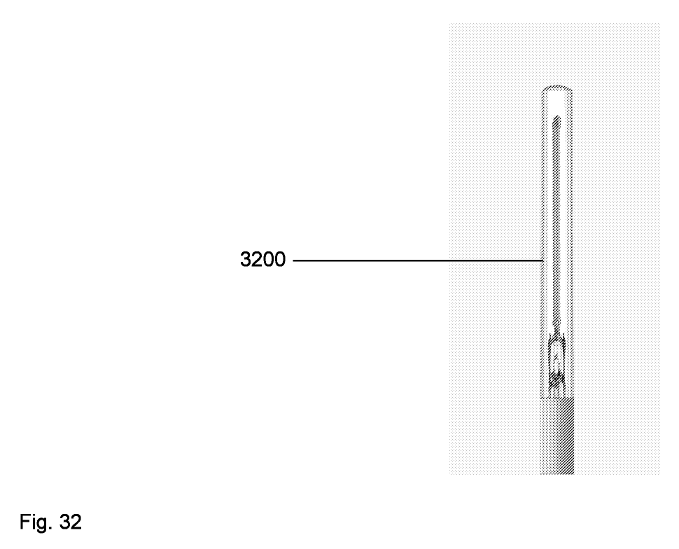

FIG. 32 shows a side view of an embodiment of an illumination device according to this disclosure. FIG. 37 shows a side view of an embodiment of an illumination device according to this disclosure. An illumination device 3200 comprises the bulb 100. Note that the platform/base 102 may contain a battery, which may be cylindrical, rechargeable, or removable, as disclosed herein. Therefore, as shown in FIG. 37, the device 3200 may function as a flashlight, a traffic/night wand, or a light saber toy. For example, if the casing 104 is sufficiently durable and securely attached to the platform/base 102, and if the filaments 120 are sufficiently secure within the casing 104 and secured to the platform/base 102, then a pair of devices 3200 can be used to stage a mock light saber match, where the platform/base 102 may function as a handle of the light saber and the casing 104 or the filaments 120 can provide illumination of various colors, such as red, green, blue, or others, as disclosed herein. Also, note that the platform/base 102 may comprise the selector 215 configured to dim the bulb 100.

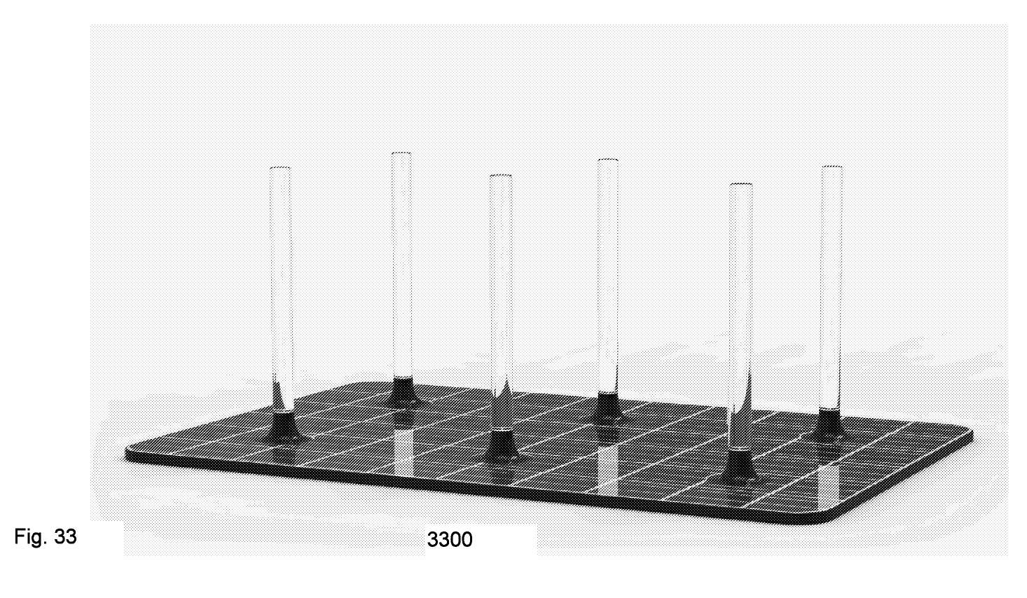

FIG. 33 shows a perspective view of an embodiment of a solar-powered lantern according to this disclosure. A solar-powered lantern 3300 comprises a single base 900 with a plurality of receivers 906, where each of the receivers 906 supports a bulb 100, as disclosed herein, which may output illumination in a single manner or multiple distinct manners.

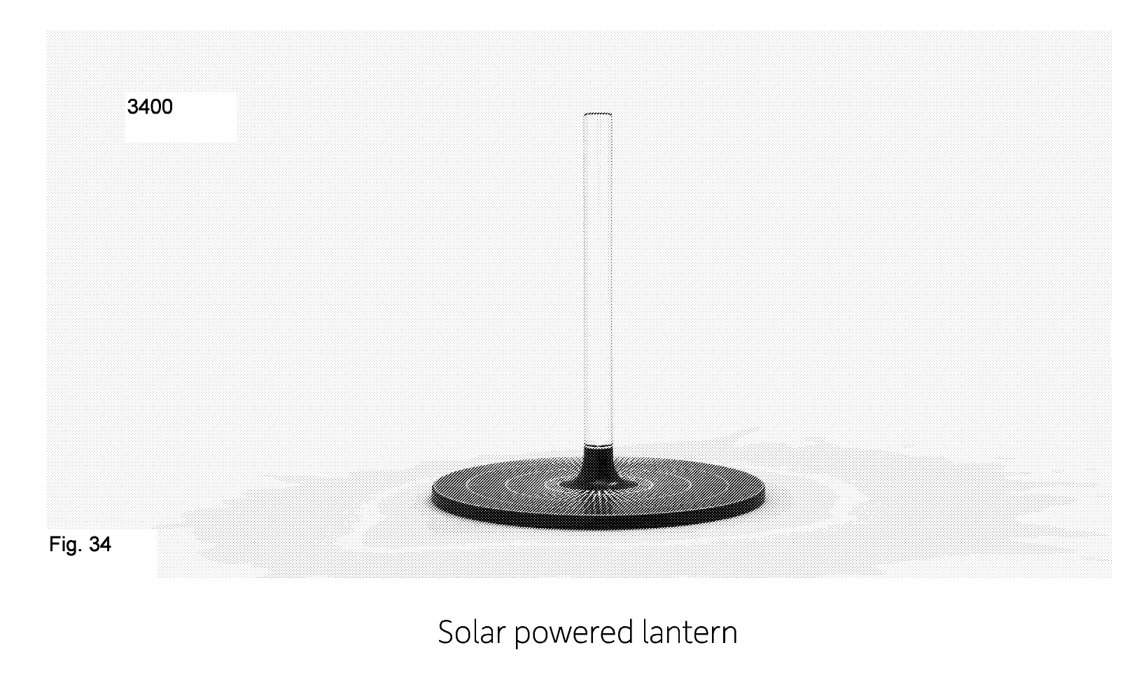

FIG. 34 shows a perspective view of an embodiment of a solar-powered lantern according to this disclosure. A solar-powered lantern 3400 comprises a single base 900 with a single receiver 906 supporting a bulb 100, as disclosed herein.

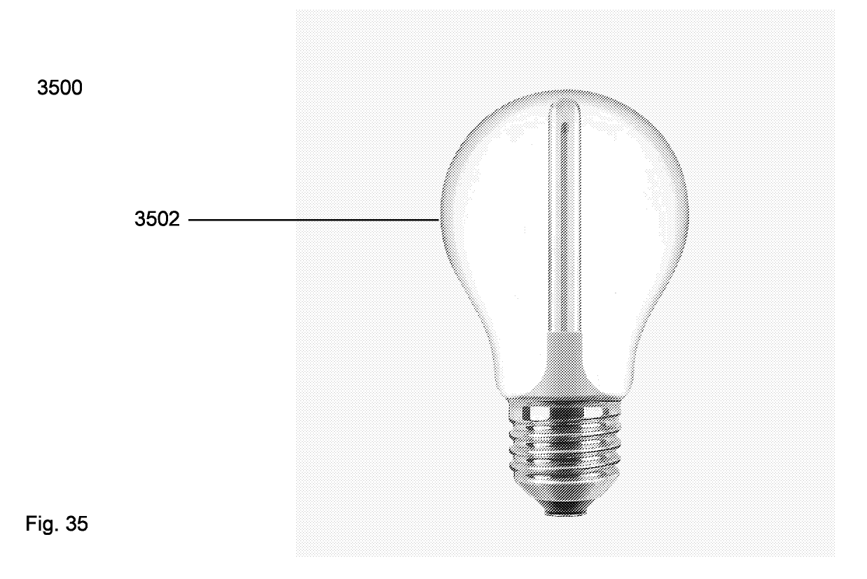

FIG. 35 shows a side view of an embodiment of a light bulb according to this disclosure. A light bulb 3500 comprises the base 200, the bulb 100, and a casing 3502 coupled to the base 200, as disclosed herein, and encasing the bulb 100. Note that the casing 3502 is bulbous or pear-shaped, but other shapes are possible.

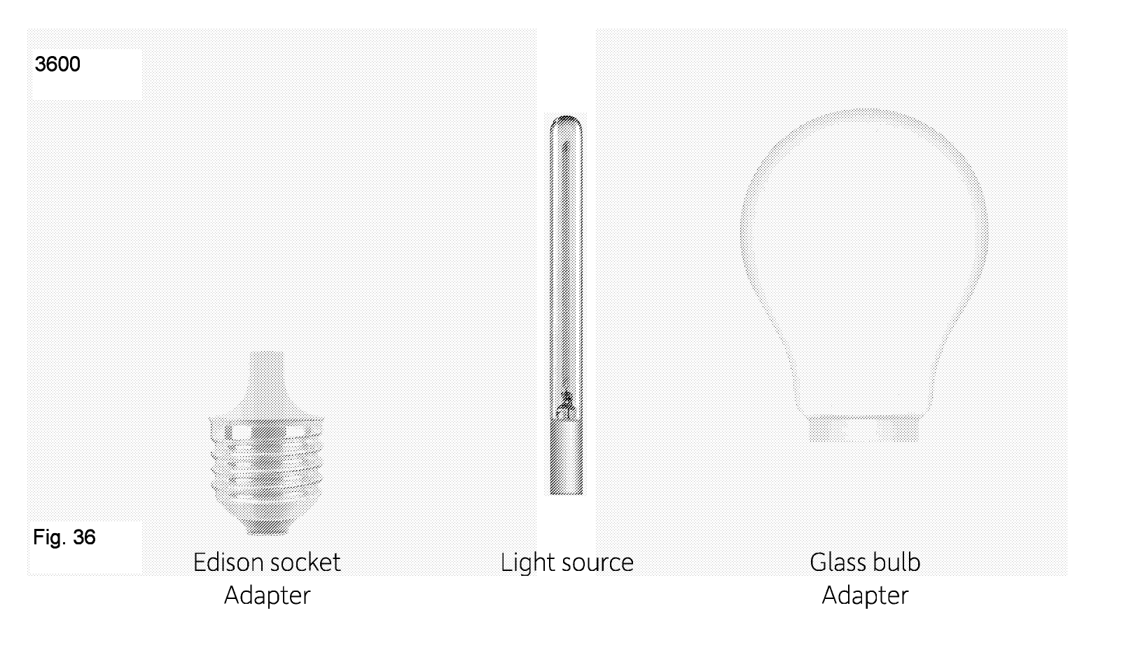

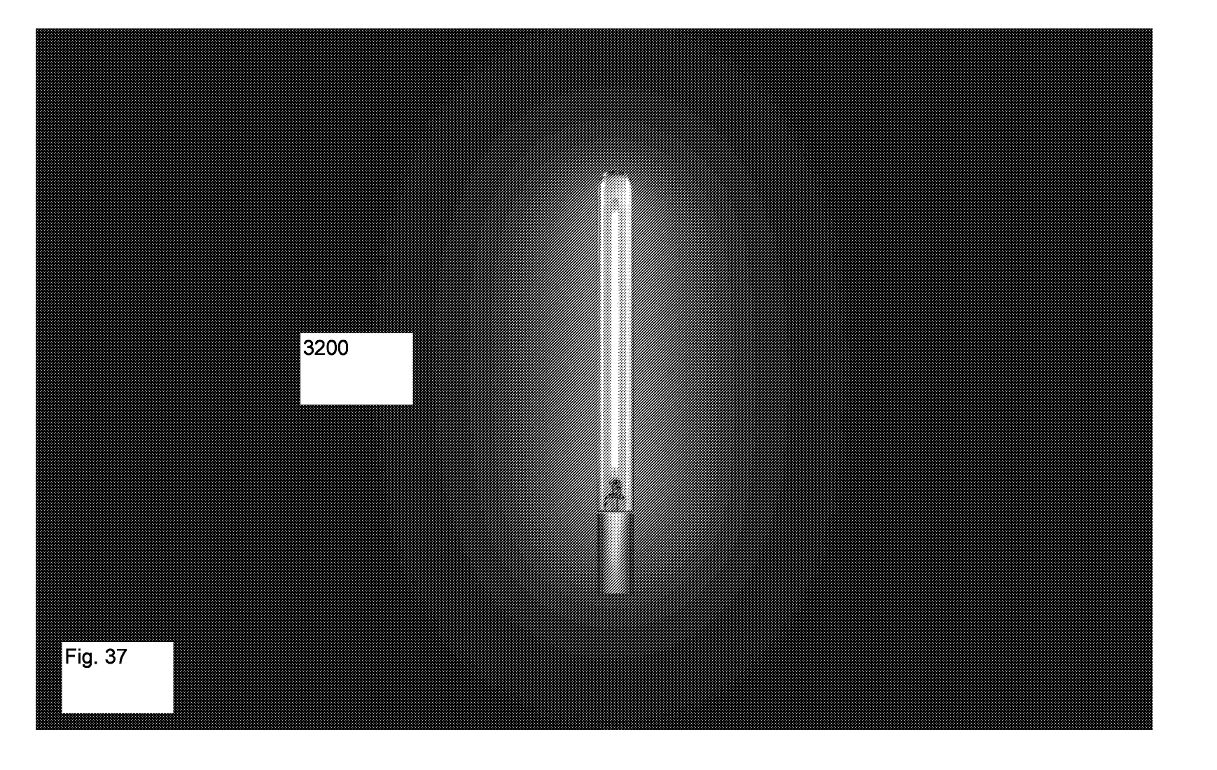

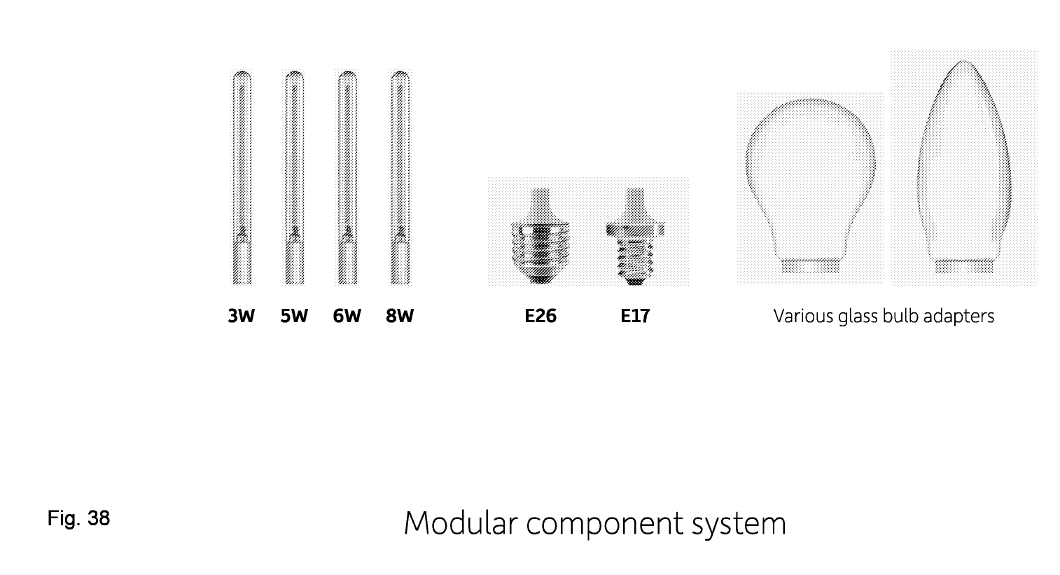

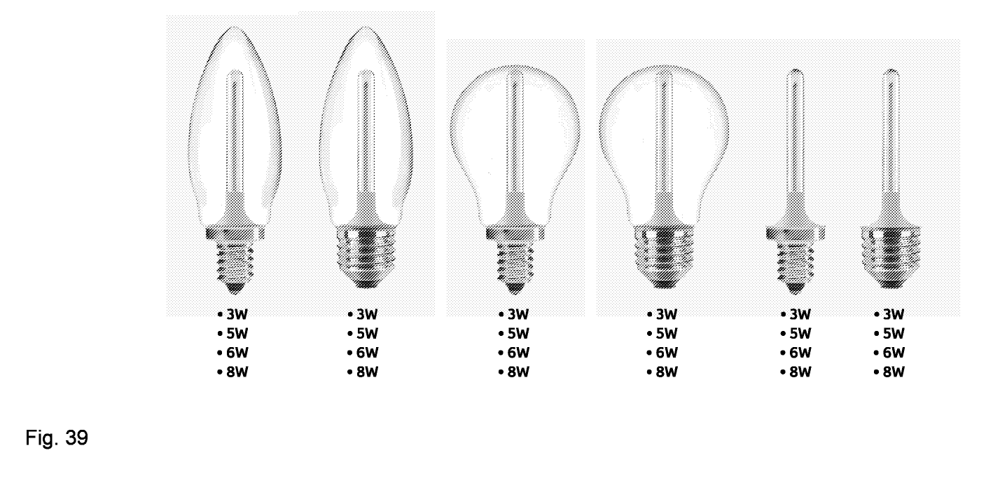

FIG. 36 shows a side view of an embodiment of a module assembly according to this disclosure. FIG. 38 shows a side view of an embodiment of a modular component system according to this disclosure. FIG. 39 shows a side view of an embodiment of a use of a modular component system according to this disclosure. A module assembly 3600 comprises an Edison socket adapter, such as the base 200, a light source, such as the bulb 100, and the casing 3502, all of which are modularly interchangeable.

In some embodiments, the bulb 100 has a minimum 400 lumen output, a Lighting Science Group Corporation biological spectrum with initial 3000 K correlated color temperature (CCT) and 80 color rendering index (CRI), at least one LED filament strip; a flip-chip type LED die to allow a high LED die attachment density on each filament, a high voltage DC input, an input power level of from about 3 to about 6 watts, inclusively, a glass material, such as a temper glass/low iron soda-lime glass/equivalent optically efficient material, an inert gas filled for thermal conduction, a dimension of fitting into ANSI C78.21 Standard A19 shape envelope, a base material, such as metal/thermal plastic, a light source attachment mechanism, such as push & pull/twist lock/magnetic latching/screw, an emergency battery backup.

In some embodiments, the base 200 can have an AC input from about 100 volts to about 277 volts, inclusively, a DC output, which may vary based on a LED filament strip configuration, a dimming circuit, an optional integrated wireless (WiFi/BLE)/ wired (PLC) control module, a screw fitting size, such as E25/E26/E27/GU-24, and a screw base material, such as metal/thermal plastic.

In some embodiments, a globe adapter, such as the casing 3502, can have a glass, temper glass/low iron soda-lime glass/plastic, stone, or other similar material, and be variably dimensioned based on ANSI C78.21 light bulb envelopes, and a globe attachment mechanism, such as threading or fastening, adhering, mating, or others.

In some embodiments, the base 900, such as an off-grid power source base, may have a solar panel, such as monocrystalline/polycrystalline/thin-film solar cell, a battery, such as Li-Polymer/LiFePO4/Supercapacitor, a self-learning battery management system for optimizing charging/discharging cycles, a weather-resistance structure/sealing and drop-resistance for outdoor use, an optional wireless module (WiFi/BLE/GSM/GPS), and a folding capability for mobility.

In some embodiments, a package, such as at least one of the containers 702, 704, or 2900, may be 100% biodegradable/compostable and recyclable material, may be a single box package, such as 20 units of slim glass bulb light sources, or may be a single standard container, which may contain about 11 million PCS slim glass bulb light sources, or 2.2 million PCS E26 screw base adapters, or 1.83 million PCS combination of slim glass bulb light source and E25/E26/E27 screw base adapters.

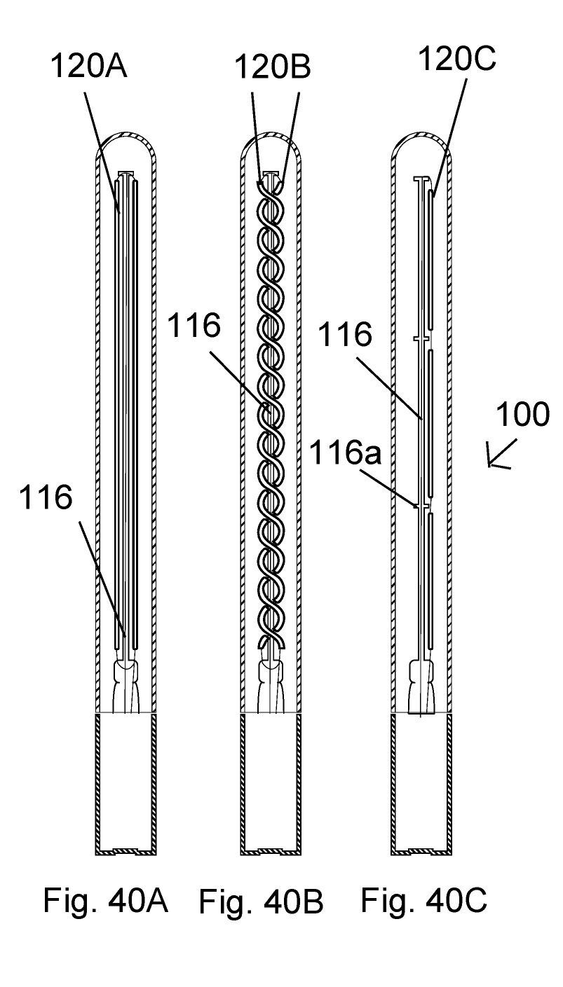

FIGS. 40A-40C show a plurality of side views of a plurality of embodiments of a plurality of light bulbs, where each of the light bulbs includes a plurality of LED filaments of various optical properties according to this disclosure. In particular, FIGS. 40A-40C show the light bulbs 100 where the light bulbs 100 differ from each other in filament structure, extension, orientation, or function. For example, FIG. 40A shows the filaments 120A longitudinally extending parallel to each other along the support column 116, where the filaments 120A differ from each other in optical properties or characteristics, such as color, luminosity, color temperature, or others, whether dependent or independent of each other. Note that although FIG. 40A shows two of the filaments 120A, more than two of the filaments 120A can be used, such as at least three, four, five, six, seven, eight, or more, in any longitudinal pattern. Likewise, FIG. 40B shows the filaments 120B longitudinally braiding about the support column 116, where the filaments 120B differ from each other in optical properties or characteristics, such as color, luminosity, color temperature, or others, whether dependent or independent of each other. Note that although FIG. 40B shows two of the filaments 120B, more than two of the filaments 120B can be used, such as at least three, four, five, six, seven, eight, or more, in any braiding pattern. Similarly, FIG. 40C shows the filaments 120C longitudinally extending one-above-another along a common side of the support column 116 and parallel to the support column 116, with the filaments 120C being either electrically coupled to each other, whether in series or parallel, or being electrically isolated from one another, yet segmented from each other by a plurality of spacers 116a perpendicularly extending from the support column 116. Therefore, as shown in FIGS. 40A-40C, the filaments 120A, 120B, or 120C can be identical to or different from each other in any permutational or combinatory manner, such as via filament structure, extension, orientation, or function, such as color, luminosity, color temperature, or others, whether dependent or independent of each other. For example, each of the filaments 120A, 120B, or 120C can be illuminated additively or alternatively and can create a blend of various colors, luminosities, color temperatures or others, or a single color, luminosity, or color temperature.

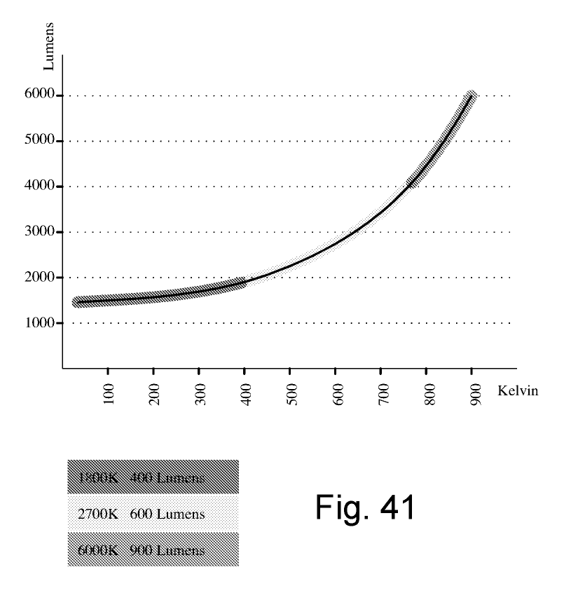

FIG. 41 shows a diagram depicting an embodiment of a relationship between a luminosity scale and a Kelvin scale according to this disclosure. Note that for some embodiments, there is a relationship between an increase in color temperature and luminosity.

In some embodiments, various functions or acts can take place at a given location and/or in connection with the operation of one or more apparatuses or systems. In some embodiments, a portion of a given function or act can be performed at a first device or location, and a remainder of the function or act can be performed at one or more additional devices or locations.

The corresponding structures, materials, acts, and equivalents of all means or step plus function elements in the claims below are intended to include any structure, material, or act for performing the function in combination with other claimed elements as specifically claimed. The embodiments were chosen and described in order to best explain the principles of the disclosure and the practical application, and to enable others of ordinary skill in the art to understand the disclosure for various embodiments with various modifications as are suited to the particular use contemplated.

The diagrams depicted herein are illustrative. There can be many variations to the diagram or the steps (or operations) described therein without departing from the spirit of the disclosure. For instance, the steps can be performed in a differing order or steps can be added, deleted or modified. All of these variations are considered a part of the disclosure. It will be understood that those skilled in the art, both now and in the future, can make various improvements and enhancements which fall within the scope of the claims which follow.

The description of this disclosure has been presented for purposes of illustration and description, but is not intended to be fully exhaustive and/or limited to the disclosure in the form disclosed. Many modifications and variations in techniques and structures will be apparent to those of ordinary skill in an art without departing from a scope and spirit of this disclosure as set forth in the claims that follow. Accordingly, such modifications and variations are contemplated as being a part of this disclosure. A scope of this disclosure is defined by various claims, which include known equivalents and unforeseeable equivalents at a time of filing of this disclosure.

1. A device comprising:
a light bulb including a platform, a casing, and an LED filament, wherein the platform is coupled to the casing, wherein the platform is coupled to the LED filament, wherein the casing encases the LED filament, wherein the casing is tubular, wherein the LED filament extends longitudinally along the casing.

2. The device of claim 1, wherein the casing includes an end portion distal to the platform, wherein the casing is uniform in diameter between the platform and the end portion.

3. The device of any one of claims 1-2, wherein the platform includes a female portion via which the LED filament is powered.

4. The device of any one of claims 1-2, wherein the platform includes a male portion via which the LED filament is powered.

5. The device of any one of claims 1-4, wherein the casing is rectilinear longitudinally.

6. The device of any one of claims 1-5, wherein the platform includes a sidewall that is flush with the casing.

7. The device of any one of claims 1-6, wherein the casing includes a length that extends in a direction away from the platform, wherein the casing is polygonal in cross-section along a plane transverse to the length.

8. The device of any one of claims 1-6, wherein the casing includes a length that extends in a direction away from the platform, wherein the casing is corner-less in cross-section along a plane transverse to the length.

9. The device of any one of claims 1-8, wherein the LED filament includes a plurality of LED filaments.

10. The device of any one of claims 1-9, wherein the LED filaments extend parallel to each other.

11. The device of any one of claims 1-9, wherein the LED filaments extend one above another.

12. The device of any one of claims 1-9, wherein the light bulb includes a support column, wherein the LED filaments are braided about the support column.

13. The device of any one of claims 1-11, wherein the LED filaments extend along a common side of the casing.

14. The device of any one of claims 1-13, further comprising:
an adapter comprising a screw and a wall, wherein the screw is coupled to the wall, wherein the wall defines a well configured to receive the light bulb and power the LED filament.

15. The device of any one of claims 1-14, further comprising:
a disk including a plurality of photovoltaic cells;
a receiver supported via the disk, wherein the receiver is configured to receive the light bulb and power the LED filament based on the photovoltaic cells.

16. The device of claim 15, wherein the disk is jigsaw tile shaped.

17. A device comprising:
an adapter including a screw and a wall, wherein the screw is coupled to the wall, wherein the wall defines a well configured to receive a light bulb and power the light bulb.

18. The device of claim 17, wherein the well includes a base including a male portion configured to engage the light bulb.

19. The device of claim 17, wherein the well includes a base including a female portion configured to engage the light bulb.

20. The device of any one of claims 17-19, wherein the wall includes a plurality of walls that intersect.

21. The device of any one of claims 17-20, wherein the well includes a plurality of wells.

22. The device of any one of claims 17-21, wherein the screw contains a memory.

23. The device of any one of claims 17-22, wherein the screw contains a processor.

24. The device of any one of claims 17-23, wherein the screw contains a sensor.

25. The device of any one of claims 17-24, wherein the screw contains a transmitter.

26. The device of any one of claims 17-25, wherein the screw contains a receiver.

27. The device of any one of claims 17-26, wherein the well contains a sidewall including a tab configured to engage the light bulb.

28. The device of any one of claims 17-27, wherein the well is configured to engage with the light bulb magnetically.

29. The device of any one of claims 17-28, wherein the well is configured for fastenably receiving the light bulb.

30. The device of any one of claims 17-29, wherein the screw includes an energy store.

31. The device of any one of claims 17-30, wherein the wall includes a gradual level selector configured to control the light bulb.

32. A device comprising:
a disk including a plurality of photovoltaic cells; and
a receiver supported via the disk, wherein the receiver is configured to receive a light bulb and power the light bulb based on the photovoltaic cells.

33. The device of claim 32, wherein the receiver is funnel-shaped.

34. The device of any one of claims 32-33, wherein the receiver includes a male portion configured to engage the light bulb.

35. The device of any one of claims 32-33, wherein the receiver includes a female portion configured to engage the light bulb.

36. The device of any one of claims 32-35, wherein the disk is circularly-shaped.

37. The device of any one of claims 32-35, wherein the disk is square-shaped.

38. The device of any one of claims 32-35, wherein the disk is jigsaw tile shaped.

39. The device of any one of claims 32-38, wherein the receiver includes a well configured to receive the light bulb, wherein the well contains a sidewall including a tab configured to engage the light bulb.

40. The device of any one of claims 32-39, wherein the receiver includes a well configured to receive the light bulb, wherein the well is configured to engage with the light bulb magnetically.

41. The device of any one of claims 32-40, wherein the receiver includes a well configured to receive the light bulb, wherein the well is configured for fastenably receiving the light bulb.

42. The device of any one of claims 32-41, wherein the receiver includes a plurality of receivers.

43. A device comprising:
a light fixture comprising a wall with a non-threaded well, wherein the non-threaded well is configured to securely receive a light bulb and power the light bulb.
